(19) United States
(12) Patent Application Publication
(10) Pub. No.: US 2022/0030253 A1
(43) Pub. Date: Jan. 27, 2022

(54) SLICE ENTRY POINTS IN VIDEO CODING

(71) Applicant: Huawei Technologies Co., Ltd., Shenzhen (CN)

(72) Inventor: Ye-Kui Wang, San Diego, CA (US)

(21) Appl. No.: 17/497,641

(22) Filed: Oct. 8, 2021

Related U.S. Application Data
(63) Continuation of application No. PCT/US2020/027497, filed on Apr. 9, 2020.
(60) Provisional application No. 62/832,128, filed on Apr. 10, 2019.

(51) Int. Cl. H04N 19/174; H04N 19/436

(52) U.S. Cl. CPC H04N 19/174; H04N 19/436

(57) ABSTRACT

A video coding mechanism is disclosed. The mechanism includes receiving a bitstream comprising a slice. A number of entry points (NumEntryPoints) in the slice is derived. Offsets for subsets of coded slice data with subset index values ranging from zero to the NumEntryPoints are determined. The slice is decoded based on the offsets for the subsets of the coded slice data. The slice is forwarded for display as part of a decoded video sequence.

### CROSS-REFERENCE TO RELATED APPLICATIONS

This application is a continuation of International Application No. PCT/US2020/027497 filed on Apr. 9, 2020 by Futurewei Technologies, Inc., and titled “Slice Entry Points in Video Coding,” which claims the benefit of U.S. Provisional Patent Application No. 62/832,128 filed Apr. 10, 2019 by Ye-Kui Wang and titled “Video Coding Improvements,” each of which is hereby incorporated by reference.

### TECHNICAL FIELD

The present disclosure is generally related to video coding, and is specifically related to determining entry points for coded data in a slice of a picture in video coding.

### BACKGROUND

The amount of video data needed to depict even a relatively short video can be substantial, which may result in difficulties when the data is to be streamed or otherwise communicated across a communications network with limited bandwidth capacity. Thus, video data is generally compressed before being communicated across modern day telecommunications networks. The size of a video could also be an issue when the video is stored on a storage device because memory resources may be limited. Video compression devices often use software and/or hardware at the source to code the video data prior to transmission or storage, thereby decreasing the quantity of data needed to represent digital video images. The compressed data is then received at the destination by a video decompression device that decodes the video data. With limited network resources and ever increasing demands of higher video quality, improved compression and decompression techniques that improve compression ratio with little to no sacrifice in image quality are desirable.

### SUMMARY

In an embodiment, the disclosure includes a method implemented by a decoder, the method comprising: receiving, by a receiver of the decoder, a bitstream comprising a slice; deriving, by a processor of the decoder, a number of entry points (NumEntryPoints) in the slice; determining, by the processor, offsets for subsets of coded slice data with subset index values ranging from zero to the NumEntryPoints; decoding, by the processor, the slice based on the offsets for the subsets of the coded slice data; and forwarding, by the processor, the slice for display as part of a decoded video sequence. In some video coding systems, the encoder signals a num_entry_point_offsets value for each slice. The decoder then sets a NumEntryPoints value based on the bitstream. This value is employed to determine an offset for each group of coded data in the slice. These groups can then be decoded using the offsets. The present example employs a mechanism for determining the NumEntryPoints value without signaling the value in the bitstream. The NumEntryPoints can then be employed to obtain the offsets for slice subsets, such as coding tree unit (CTU) rows, prior to reconstructing the subsets and therefore the slice. For example, the mechanisms may be employed to derive the NumEntryPoints for a slice when the slice is coded according to wavefront parallel processing (WPP). The NumEntryPoints may be derived based on a size of the WPP/CTU rows, a size of the WPP/CTU columns, based on a number of CTUs in the slice, and/or based on CTU and/or slice addresses. This approach removes a signaled value for each slice header, and hence for each slice in the video stream. A picture may include multiple slices. Further, a video sequence may include thousands of pictures. Therefore, removing num_entry_point_offsets from the bitstream significantly reduces video stream size, increases coding efficiency, and reduces memory and network resource usage at both the encoder and the decoder.

Optionally, in any of the preceding aspects, another implementation of the aspect provides, wherein the NumEntryPoints is derived when the slice is coded according to wavefront parallel processing (WPP).

Optionally, in any of the preceding aspects, another implementation of the aspect provides, wherein the bitstream comprises a slice header, and wherein the slice header does not include a value corresponding to the number of entry point offsets in the slice.

Optionally, in any of the preceding aspects, another implementation of the aspect provides, wherein the NumEntryPoints is derived based on a size of rows in the slice.

Optionally, in any of the preceding aspects, another implementation of the aspect provides, wherein the NumEntryPoints is derived based on a size of columns in the slice.

Optionally, in any of the preceding aspects, another implementation of the aspect provides, wherein the NumEntryPoints is derived based on a number of coding tree units (CTUs) in the slice.

Optionally, in any of the preceding aspects, another implementation of the aspect provides, wherein the NumEntryPoints is derived based on addresses in the slice.

Optionally, in any of the preceding aspects, another implementation of the aspect provides, wherein the NumEntryPoints is derived based on a size of the slice.

In an embodiment, the disclosure includes a method implemented in an encoder, the method comprising: obtaining, by a processor of the encoder, a reference slice of a coded reference picture; deriving, by the processor, a NumEntryPoints in the reference slice; determining, by the processor, offsets for subsets of coded data in the reference slice based on the NumEntryPoints; decoding, by the processor, the reference slice of the coded reference picture based on the offsets for the subsets of the coded data in the reference slice; encoding, by the processor, a current slice into a bitstream based on the reference slice; and storing, by a memory coupled to the processor, the bitstream for communication toward a decoder. In some video coding systems, the encoder signals a num_entry_point_offsets value for each slice. The decoder then sets a NumEntryPoints value based on the bitstream. This value is employed to determine an offset for each group of coded data in the slice. These groups can then be decoded using the offsets. The present example employs a mechanism for determining the NumEntryPoints value without signaling the value in the bitstream. The NumEntryPoints can then be employed to obtain the offsets for slice subsets, such as coding tree unit (CTU) rows, prior to reconstructing the subsets and therefore the slice. For example, the mechanisms may be employed to derive the NumEntryPoints for a slice when the slice is coded according to wavefront parallel processing (WPP). The NumEntryPoints may be derived based on a size of the WPP/CTU rows, a size of the WPP/CTU columns, based on a number of CTUs in the slice, and/or based on CTU and/or slice addresses. This approach removes a signaled value for each slice header, and hence for each slice in the video stream. A picture may include multiple slices. Further, a video sequence may include thousands of pictures. Therefore, removing num_entry_point_offsets from the bitstream significantly reduces video stream size, increases coding efficiency, and reduces memory and network resource usage at both the encoder and the decoder.

Optionally, in any of the preceding aspects, another implementation of the aspect provides, wherein the NumEntryPoints is derived when the reference slice is coded according to WPP.

Optionally, in any of the preceding aspects, another implementation of the aspect provides, wherein the bitstream comprises a slice header, and wherein the slice header does not include a value corresponding to the number of entry point offsets in the reference slice.

Optionally, in any of the preceding aspects, another implementation of the aspect provides, wherein the NumEntryPoints is derived based on a size of rows in the reference slice.

Optionally, in any of the preceding aspects, another implementation of the aspect provides, wherein the NumEntryPoints is derived based on a size of columns in the reference slice.

Optionally, in any of the preceding aspects, another implementation of the aspect provides, wherein the NumEntryPoints is derived based on a number of CTUs in the reference slice.

Optionally, in any of the preceding aspects, another implementation of the aspect provides, wherein the NumEntryPoints is derived based on addresses in the reference slice.

Optionally, in any of the preceding aspects, another implementation of the aspect provides, wherein the NumEntryPoints is derived based on a size of the reference slice.

In an embodiment, the disclosure includes a video coding device comprising: a processor, a receiver coupled to the processor, a memory coupled to the processor, and a transmitter coupled to the processor, wherein the processor, receiver, memory, and transmitter are configured to perform the method of any of the preceding aspects.

In an embodiment, the disclosure includes a non-transitory computer readable medium comprising a computer program product for use by a video coding device, the computer program product comprising computer executable instructions stored on the non-transitory computer readable medium such that when executed by a processor cause the video coding device to perform the method of any of the preceding aspects.

In an embodiment, the disclosure includes a decoder comprising: a receiving means for receiving a bitstream comprising a slice; a deriving means for deriving a NumEntryPoints in the slice; a determining means for determining offsets for subsets of coded slice data with subset index values ranging from zero to the NumEntryPoints; a decoding means for decoding the slice based on the offsets for the subsets of the coded slice data; and a forwarding means for forwarding the slice for display as part of a decoded video sequence.

Optionally, in any of the preceding aspects, another implementation of the aspect provides, wherein the decoder is further configured to perform the method of any of the preceding aspects.

In an embodiment, the disclosure includes an encoder comprising: an obtaining means for obtaining a reference slice of a coded reference picture; a deriving means for deriving a NumEntryPoints in the reference slice; a determining means for determining offsets for subsets of coded data in the reference slice based on the NumEntryPoints; a coding means for: decoding the reference slice of the coded reference picture based on the offsets for the subsets of the coded data in the reference slice; and encoding a current slice into a bitstream based on the reference slice; and a storing means for storing the bitstream for communication toward a decoder.

Optionally, in any of the preceding aspects, another implementation of the aspect provides, wherein the encoder is further configured to perform the method of any of the preceding aspects.

For the purpose of clarity, any one of the foregoing embodiments may be combined with any one or more of the other foregoing embodiments to create a new embodiment within the scope of the present disclosure.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a flowchart of an example method of coding a video signal.

FIG. 2 is a schematic diagram of an example coding and decoding (codec) system for video coding.

FIG. 3 is a schematic diagram illustrating an example video encoder.

FIG. 4 is a schematic diagram illustrating an example video decoder.

FIG. 5 is a schematic diagram illustrating an example mechanism of wavefront parallel processing (WPP).

FIG. 6 is a schematic diagram illustrating an example bitstream.

FIG. 7 is a schematic diagram of an example video coding device.

FIG. 8 is a flowchart of an example method of encoding a video sequence into a bitstream without signaling a number of entry points (NumEntryPoints) for the slices.

FIG. 9 is a flowchart of an example method of deriving a NumEntryPoints to decode a video sequence when NumEntryPoints is not contained in a bitstream.

FIG. 10 is a schematic diagram of an example system for coding a video sequence into a bitstream without signaling NumEntryPoints.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

The following terms are defined as follows unless used in a contrary context herein. Specifically, the following definitions are intended to provide additional clarity to the present disclosure. However, terms may be described differently in different contexts. Accordingly, the following definitions should be considered as a supplement and should not be considered to limit any other definitions of descriptions provided for such terms herein.

A bitstream is a sequence of bits including video data that is compressed for transmission between an encoder and a decoder. An encoder is a device that is configured to employ encoding processes to compress video data into a bitstream. A decoder is a device that is configured to employ decoding processes to reconstruct video data from a bitstream for display. A picture is a complete image that is intended for complete or partial display to a user at a corresponding instant in a video sequence. A reference picture is a picture that contains reference samples that can be used when coding other pictures by reference according to inter-prediction. A coded picture is a representation of a picture that is coded according to inter-prediction or intra-prediction, is contained in a single access unit in a bitstream, and contains a complete set of the coding tree units (CTUs) of the picture. A slice is a partition of a picture that contains an integer number of complete tiles or an integer number of consecutive complete CTU rows within a tile of the picture, where the slice and all sub-divisions are exclusively contained in a single network abstraction layer (NAL) unit. A reference slice is a slice of a reference picture that contains reference samples or used when coding other slices by reference according to inter-prediction. A slice header is a part of a coded slice containing data elements pertaining to all tiles or CTU rows within a tile represented in the slice. An entry point is a bit location in a bitstream containing a first bit of video data for a corresponding subset of a coded slice. An offset is a distance in bits between a known bit location and an entry point. A subset is a sub-division of a set. For example, when a slice is the set, a tile, a CTU/coding tree block (CTB) row, or a CTU/CTB is a subset of the set. A coding tree unit (CTU) is a group of samples of a predefined size that can be partitioned by a coding tree. A CTU row is a group of CTUs that extend horizontally between a left slice boundary and a right slice boundary. A CTU column is a group of CTUs that extend vertically between a top slice boundary and a bottom slice boundary. A CTB is a portion of a CTU that contains only luma samples, only red difference chroma samples, or only blue difference chroma samples. A CTB row/CTB column is a CTU row/column that contains only luma samples, only red difference chroma samples, or only blue difference chroma samples. It should be noted that CTU and CTB may be used interchangeably in many contexts. Wavefront parallel processing (WPP) is a mechanism of coding CTU/CTB rows of a slice with a delay to allow each row to be decoded in parallel by different threads. A slice address is an identifiable location of a slice or sub-portion thereof

The following acronyms are used herein, Coded Video Sequence (CVS), Decoded Picture Buffer (DPB), Instantaneous Decoding Refresh (IDR), Intra Random Access Point (TRAP), Joint Video Experts Team (JVET), Least Significant Bit (LSB), Most Significant Bit (MSB), Network Abstraction Layer (NAL), Picture Order Count (POC), Raw Byte Sequence Payload (RBSP), Real-Time Transport Protocol (RTP), Sequence Parameter Set (SPS), Versatile Video Coding (VVC), Working Draft (WD), and Wavefront Parallel Processing (WPP).

Many video compression techniques can be employed to reduce the size of video files with minimal loss of data. For example, video compression techniques can include performing spatial (e.g., intra-picture) prediction and/or temporal (e.g., inter-picture) prediction to reduce or remove data redundancy in video sequences. For block-based video coding, a video slice (e.g., a video picture or a portion of a video picture) may be partitioned into video blocks, which may also be referred to as treeblocks, coding tree blocks (CTBs), coding tree units (CTUs), coding units (CUs), and/or coding nodes. Video blocks in an intra-coded (I) slice of a picture are coded using spatial prediction with respect to reference samples in neighboring blocks in the same picture. Video blocks in an inter-coded unidirectional prediction (P) or bidirectional prediction (B) slice of a picture may be coded by employing spatial prediction with respect to reference samples in neighboring blocks in the same picture or temporal prediction with respect to reference samples in other reference pictures. Pictures may be referred to as frames and/or images, and reference pictures may be referred to as reference frames and/or reference images. Spatial or temporal prediction results in a predictive block representing an image block. Residual data represents pixel differences between the original image block and the predictive block. Accordingly, an inter-coded block is encoded according to a motion vector that points to a block of reference samples forming the predictive block and the residual data indicating the difference between the coded block and the predictive block. An intra-coded block is encoded according to an intra-coding mode and the residual data. For further compression, the residual data may be transformed from the pixel domain to a transform domain. These result in residual transform coefficients, which may be quantized. The quantized transform coefficients may initially be arranged in a two-dimensional array. The quantized transform coefficients may be scanned in order to produce a one-dimensional vector of transform coefficients. Entropy coding may be applied to achieve even more compression. Such video compression techniques are discussed in greater detail below.

To ensure an encoded video can be accurately decoded, video is encoded and decoded according to corresponding video coding standards. Video coding standards include International Telecommunication Union (ITU) Standardization Sector (ITU-T) H.261, International Organization for Standardization/International Electrotechnical Commission (ISO/IEC) Motion Picture Experts Group (MPEG)-1 Part 2, ITU-T H.262 or ISO/IEC MPEG-2 Part 2, ITU-T H.263, ISO/IEC MPEG-4 Part 2, Advanced Video Coding (AVC), also known as ITU-T H.264 or ISO/IEC MPEG-4 Part 10, and High Efficiency Video Coding (HEVC), also known as ITU-T H.265 or MPEG-H Part 2. AVC includes extensions such as Scalable Video Coding (SVC), Multiview Video Coding (MVC) and Multiview Video Coding plus Depth (MVC+D), and three dimensional (3D) AVC (3D-AVC). HEVC includes extensions such as Scalable HEVC (SHVC), Multiview HEVC (MV-HEVC), and 3D HEVC (3D-HEVC). The joint video experts team (JVET) of ITU-T and ISO/IEC has begun developing a video coding standard referred to as Versatile Video Coding (VVC). VVC is included in a Working Draft (WD), which includes JVET-N1001-v1.

Video coding systems may employ many different mechanisms to encode a video. For example, a video coding system can partition a picture into slices. In some examples, the slices are partitioned into tiles. The slices and/or tiles of the slices, depending on the example, can then be partitioned into rows of CTUs. The CTUs are then sub-divided according to coding trees into coding blocks, which are coded according to prediction mechanisms. The coded coding blocks are then included into a bitstream. In WPP, rows of CTUs and partitions thereof, are coded in parallel. For example, WPP may code one or two CTUs in a first row, depending on the example, using a first thread and then begin coding CTUs in a second row with a second thread. Once one/two CTUs in the second row are coded, a third thread may begin coding CTUs in a third row, etc. Some prediction schemes code by reference to blocks positioned above or to the left of a current block. By placing a CTU delay between initiating coding of the next row, WPP can ensure that blocks positioned above or to the left of a current block are coded before the current block is coded. This alleviates the issue of such data being potentially unavailable when the encoder begins coding the current block.

Accordingly, a large number of bits are included in a bitstream. Further, each of these bits is associated with a corresponding slice or sub-portion thereof. An array of offsets can be included in the bitstream in order to assist the decoder in interpreting the bitstream and finding relevant data. The offsets each indicate a location of corresponding data in the bitstream. An offset of a first bit of video data for a corresponding subset of a coded slice is known as an entry point. In the case of WPP, the subset is a CTU row. As such, in WPP, there may be as many entry points in a slice as the number of CTU rows in the slice. In some video coding systems, a num_entry_point_offsets is included in a slice header. The num_entry_point_offsets is a parameter that signals the number of entry point offsets that are contained in a slice, and hence indicate to the decoder the number of offsets that should be obtained from the array of offsets. The decoder can use the num_entry_point_offsets from the slice header to obtain the relevant offsets and begin decoding the corresponding CTUs. While this approach is effective, num_entry_point_offsets contains multiple bits and is signaled in every slice header. Since each picture may contain several slices and the video sequence may contain thousands of pictures, the num_entry_point_offsets is signaled many times and may have a significant aggregate impact on the amount of data in a video sequence.

Disclosed herein are mechanisms to derive a number of entry points (NumEntryPoints) value at a decoder. The NumEntryPoints can then be employed to obtain the offsets for the slice subsets (e.g., CTU rows) prior to reconstructing the subsets and therefore the slice. This allows num_entry_point_offsets to be removed from each slice header of the bitstream. These mechanisms may be employed at a decoder and/or at a hypothetical reference decoder (HRD) on an encoder. As a picture may include multiple slices and a video may contain thousands of pictures, removing this value from the bitstream significantly reduces video stream size, increases coding efficiency, and reduces memory and network resource usage at both the encoder and the decoder. For example, the mechanisms may be employed to derive the NumEntryPoints for a slice when the slice is coded according to WPP. The NumEntryPoints may be derived based on a size of the WPP/CTU rows, a size of the WPP/CTU columns, based on a number of CTUs in the slice, and/or based on CTU and/or slice addresses.

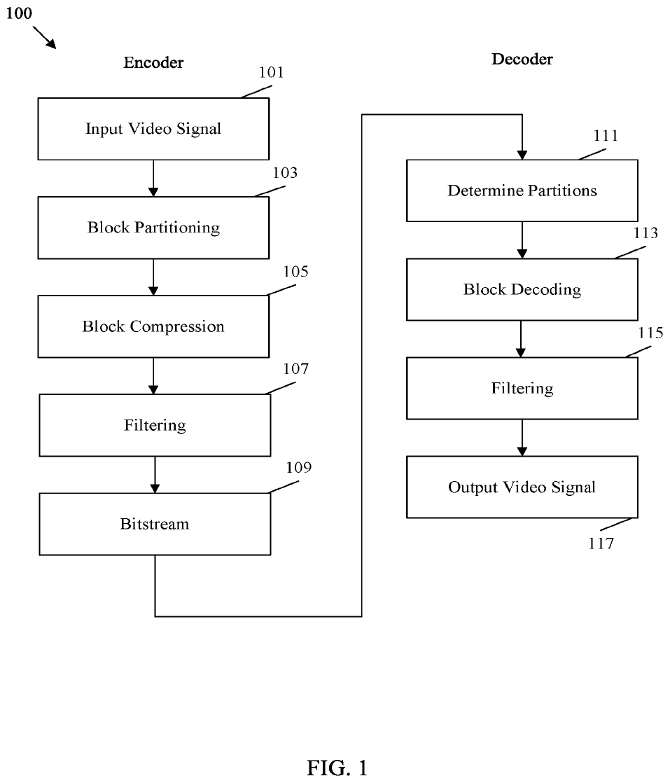

FIG. 1 is a flowchart of an example operating method 100 of coding a video signal. Specifically, a video signal is encoded at an encoder. The encoding process compresses the video signal by employing various mechanisms to reduce the video file size. A smaller file size allows the compressed video file to be transmitted toward a user, while reducing associated bandwidth overhead. The decoder then decodes the compressed video file to reconstruct the original video signal for display to an end user. The decoding process generally mirrors the encoding process to allow the decoder to consistently reconstruct the video signal.

At step 101, the video signal is input into the encoder. For example, the video signal may be an uncompressed video file stored in memory. As another example, the video file may be captured by a video capture device, such as a video camera, and encoded to support live streaming of the video. The video file may include both an audio component and a video component. The video component contains a series of image frames that, when viewed in a sequence, gives the visual impression of motion. The frames contain pixels that are expressed in terms of light, referred to herein as luma components (or luma samples), and color, which is referred to as chroma components (or color samples). In some examples, the frames may also contain depth values to support three dimensional viewing.

At step 103, the video is partitioned into blocks. Partitioning includes subdividing the pixels in each frame into square and/or rectangular blocks for compression. For example, in High Efficiency Video Coding (HEVC) (also known as H.265 and MPEG-H Part 2) the frame can first be divided into coding tree units (CTUs), which are blocks of a predefined size (e.g., sixty-four pixels by sixty-four pixels). The CTUs contain both luma and chroma samples. Coding trees may be employed to divide the CTUs into blocks and then recursively subdivide the blocks until configurations are achieved that support further encoding. For example, luma components of a frame may be subdivided until the individual blocks contain relatively homogenous lighting values. Further, chroma components of a frame may be subdivided until the individual blocks contain relatively homogenous color values. Accordingly, partitioning mechanisms vary depending on the content of the video frames.

At step 105, various compression mechanisms are employed to compress the image blocks partitioned at step 103. For example, inter-prediction and/or intra-prediction may be employed. Inter-prediction is designed to take advantage of the fact that objects in a common scene tend to appear in successive frames. Accordingly, a block depicting an object in a reference frame need not be repeatedly described in adjacent frames. Specifically, an object, such as a table, may remain in a constant position over multiple frames. Hence the table is described once and adjacent frames can refer back to the reference frame. Pattern matching mechanisms may be employed to match objects over multiple frames. Further, moving objects may be represented across multiple frames, for example due to object movement or camera movement. As a particular example, a video may show an automobile that moves across the screen over multiple frames. Motion vectors can be employed to describe such movement. A motion vector is a two-dimensional vector that provides an offset from the coordinates of an object in a frame to the coordinates of the object in a reference frame. As such, inter-prediction can encode an image block in a current frame as a set of motion vectors indicating an offset from a corresponding block in a reference frame.

Intra-prediction encodes blocks in a common frame. Intra-prediction takes advantage of the fact that luma and chroma components tend to cluster in a frame. For example, a patch of green in a portion of a tree tends to be positioned adjacent to similar patches of green. Intra-prediction employs multiple directional prediction modes (e.g., thirty-three in HEVC), a planar mode, and a direct current (DC) mode. The directional modes indicate that a current block is similar/the same as samples of a neighbor block in a corresponding direction. Planar mode indicates that a series of blocks along a row/column (e.g., a plane) can be interpolated based on neighbor blocks at the edges of the row. Planar mode, in effect, indicates a smooth transition of light/color across a row/column by employing a relatively constant slope in changing values. DC mode is employed for boundary smoothing and indicates that a block is similar/the same as an average value associated with samples of all the neighbor blocks associated with the angular directions of the directional prediction modes. Accordingly, intra-prediction blocks can represent image blocks as various relational prediction mode values instead of the actual values. Further, inter-prediction blocks can represent image blocks as motion vector values instead of the actual values. In either case, the prediction blocks may not exactly represent the image blocks in some cases. Any differences are stored in residual blocks. Transforms may be applied to the residual blocks to further compress the file.

At step 107, various filtering techniques may be applied. In HEVC, the filters are applied according to an in-loop filtering scheme. The block based prediction discussed above may result in the creation of blocky images at the decoder. Further, the block based prediction scheme may encode a block and then reconstruct the encoded block for later use as a reference block. The in-loop filtering scheme iteratively applies noise suppression filters, de-blocking filters, adaptive loop filters, and sample adaptive offset (SAO) filters to the blocks/frames. These filters mitigate such blocking artifacts so that the encoded file can be accurately reconstructed. Further, these filters mitigate artifacts in the reconstructed reference blocks so that artifacts are less likely to create additional artifacts in subsequent blocks that are encoded based on the reconstructed reference blocks.

Once the video signal has been partitioned, compressed, and filtered, the resulting data is encoded in a bitstream at step 109. The bitstream includes the data discussed above as well as any signaling data desired to support proper video signal reconstruction at the decoder. For example, such data may include partition data, prediction data, residual blocks, and various flags providing coding instructions to the decoder. The bitstream may be stored in memory for transmission toward a decoder upon request. The bitstream may also be broadcast and/or multicast toward a plurality of decoders. The creation of the bitstream is an iterative process. Accordingly, steps 101, 103, 105, 107, and 109 may occur continuously and/or simultaneously over many frames and blocks. The order shown in FIG. 1 is presented for clarity and ease of discussion, and is not intended to limit the video coding process to a particular order.

The decoder receives the bitstream and begins the decoding process at step 111. Specifically, the decoder employs an entropy decoding scheme to convert the bitstream into corresponding syntax and video data. The decoder employs the syntax data from the bitstream to determine the partitions for the frames at step 111. The partitioning should match the results of block partitioning at step 103. Entropy encoding/decoding as employed in step 111 is now described. The encoder makes many choices during the compression process, such as selecting block partitioning schemes from several possible choices based on the spatial positioning of values in the input image(s). Signaling the exact choices may employ a large number of bins. As used herein, a bin is a binary value that is treated as a variable (e.g., a bit value that may vary depending on context). Entropy coding allows the encoder to discard any options that are clearly not viable for a particular case, leaving a set of allowable options. Each allowable option is then assigned a code word. The length of the code words is based on the number of allowable options (e.g., one bin for two options, two bins for three to four options, etc.) The encoder then encodes the code word for the selected option. This scheme reduces the size of the code words as the code words are as big as desired to uniquely indicate a selection from a small sub-set of allowable options as opposed to uniquely indicating the selection from a potentially large set of all possible options. The decoder then decodes the selection by determining the set of allowable options in a similar manner to the encoder. By determining the set of allowable options, the decoder can read the code word and determine the selection made by the encoder.

At step 113, the decoder performs block decoding. Specifically, the decoder employs reverse transforms to generate residual blocks. Then the decoder employs the residual blocks and corresponding prediction blocks to reconstruct the image blocks according to the partitioning. The prediction blocks may include both intra-prediction blocks and inter-prediction blocks as generated at the encoder at step 105. The reconstructed image blocks are then positioned into frames of a reconstructed video signal according to the partitioning data determined at step 111. Syntax for step 113 may also be signaled in the bitstream via entropy coding as discussed above.

At step 115, filtering is performed on the frames of the reconstructed video signal in a manner similar to step 107 at the encoder. For example, noise suppression filters, de-blocking filters, adaptive loop filters, and SAO filters may be applied to the frames to remove blocking artifacts. Once the frames are filtered, the video signal can be output to a display at step 117 for viewing by an end user.

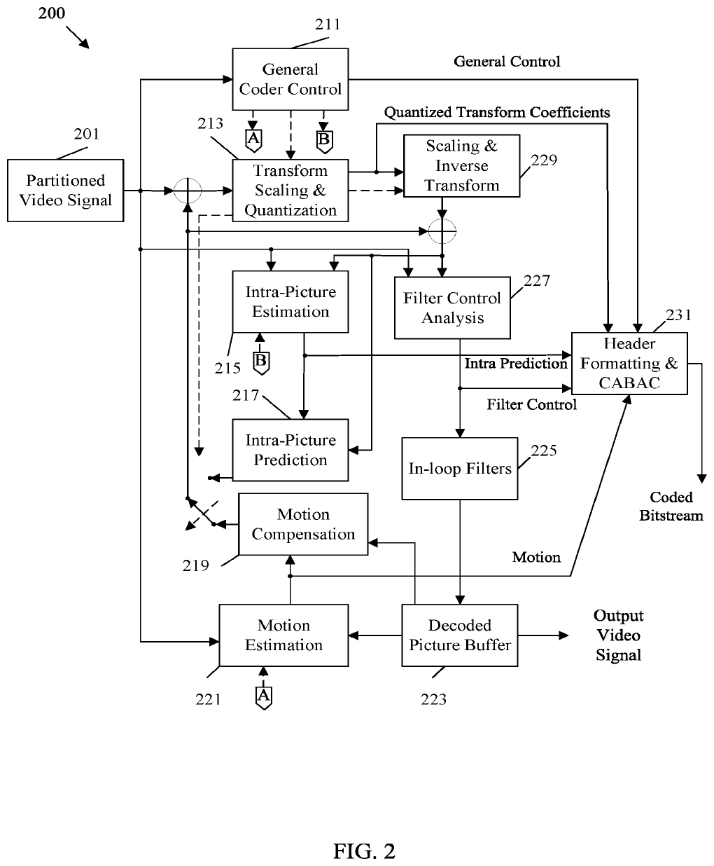

FIG. 2 is a schematic diagram of an example coding and decoding (codec) system 200 for video coding. Specifically, codec system 200 provides functionality to support the implementation of operating method 100. Codec system 200 is generalized to depict components employed in both an encoder and a decoder. Codec system 200 receives and partitions a video signal as discussed with respect to steps 101 and 103 in operating method 100, which results in a partitioned video signal 201. Codec system 200 then compresses the partitioned video signal 201 into a coded bitstream when acting as an encoder as discussed with respect to steps 105, 107, and 109 in method 100. When acting as a decoder, codec system 200 generates an output video signal from the bitstream as discussed with respect to steps 111, 113, 115, and 117 in operating method 100. The codec system 200 includes a general coder control component 211, a transform scaling and quantization component 213, an intra-picture estimation component 215, an intra-picture prediction component 217, a motion compensation component 219, a motion estimation component 221, a scaling and inverse transform component 229, a filter control analysis component 227, an in-loop filters component 225, a decoded picture buffer component 223, and a header formatting and context adaptive binary arithmetic coding (CABAC) component 231. Such components are coupled as shown. In FIG. 2, black lines indicate movement of data to be encoded/decoded while dashed lines indicate movement of control data that controls the operation of other components. The components of codec system 200 may all be present in the encoder. The decoder may include a subset of the components of codec system 200. For example, the decoder may include the intra-picture prediction component 217, the motion compensation component 219, the scaling and inverse transform component 229, the in-loop filters component 225, and the decoded picture buffer component 223. These components are now described.

The partitioned video signal 201 is a captured video sequence that has been partitioned into blocks of pixels by a coding tree. A coding tree employs various split modes to subdivide a block of pixels into smaller blocks of pixels. These blocks can then be further subdivided into smaller blocks. The blocks may be referred to as nodes on the coding tree. Larger parent nodes are split into smaller child nodes. The number of times a node is subdivided is referred to as the depth of the node/coding tree. The divided blocks can be included in coding units (CUs) in some cases. For example, a CU can be a sub-portion of a CTU that contains a luma block, red difference chroma (Cr) block(s), and a blue difference chroma (Cb) block(s) along with corresponding syntax instructions for the CU. The split modes may include a binary tree (BT), triple tree (TT), and a quad tree (QT) employed to partition a node into two, three, or four child nodes, respectively, of varying shapes depending on the split modes employed. The partitioned video signal 201 is forwarded to the general coder control component 211, the transform scaling and quantization component 213, the intra-picture estimation component 215, the filter control analysis component 227, and the motion estimation component 221 for compression.

The general coder control component 211 is configured to make decisions related to coding of the images of the video sequence into the bitstream according to application constraints. For example, the general coder control component 211 manages optimization of bitrate/bitstream size versus reconstruction quality. Such decisions may be made based on storage space/bandwidth availability and image resolution requests. The general coder control component 211 also manages buffer utilization in light of transmission speed to mitigate buffer underrun and overrun issues. To manage these issues, the general coder control component 211 manages partitioning, prediction, and filtering by the other components. For example, the general coder control component 211 may dynamically increase compression complexity to increase resolution and increase bandwidth usage or decrease compression complexity to decrease resolution and bandwidth usage. Hence, the general coder control component 211 controls the other components of codec system 200 to balance video signal reconstruction quality with bit rate concerns. The general coder control component 211 creates control data, which controls the operation of the other components. The control data is also forwarded to the header formatting and CABAC component 231 to be encoded in the bitstream to signal parameters for decoding at the decoder.

The partitioned video signal 201 is also sent to the motion estimation component 221 and the motion compensation component 219 for inter-prediction. A frame or slice of the partitioned video signal 201 may be divided into multiple video blocks. Motion estimation component 221 and the motion compensation component 219 perform inter-predictive coding of the received video block relative to one or more blocks in one or more reference frames to provide temporal prediction. Codec system 200 may perform multiple coding passes, e.g., to select an appropriate coding mode for each block of video data.

Motion estimation component 221 and motion compensation component 219 may be highly integrated, but are illustrated separately for conceptual purposes. Motion estimation, performed by motion estimation component 221, is the process of generating motion vectors, which estimate motion for video blocks. A motion vector, for example, may indicate the displacement of a coded object relative to a predictive block. A predictive block is a block that is found to closely match the block to be coded, in terms of pixel difference. A predictive block may also be referred to as a reference block. Such pixel difference may be determined by sum of absolute difference (SAD), sum of square difference (SSD), or other difference metrics. HEVC employs several coded objects including a CTU, coding tree blocks (CTBs), and CUs. For example, a CTU can be divided into CTBs, which can then be divided into CBs for inclusion in CUs. A CU can be encoded as a prediction unit (PU) containing prediction data and/or a transform unit (TU) containing transformed residual data for the CU. The motion estimation component 221 generates motion vectors, PUs, and TUs by using a rate-distortion analysis as part of a rate distortion optimization process. For example, the motion estimation component 221 may determine multiple reference blocks, multiple motion vectors, etc. for a current block/frame, and may select the reference blocks, motion vectors, etc. having the best rate-distortion characteristics. The best rate-distortion characteristics balance both quality of video reconstruction (e.g., amount of data loss by compression) with coding efficiency (e.g., size of the final encoding).

In some examples, codec system 200 may calculate values for sub-integer pixel positions of reference pictures stored in decoded picture buffer component 223. For example, video codec system 200 may interpolate values of one-quarter pixel positions, one-eighth pixel positions, or other fractional pixel positions of the reference picture. Therefore, motion estimation component 221 may perform a motion search relative to the full pixel positions and fractional pixel positions and output a motion vector with fractional pixel precision. The motion estimation component 221 calculates a motion vector for a PU of a video block in an inter-coded slice by comparing the position of the PU to the position of a predictive block of a reference picture. Motion estimation component 221 outputs the calculated motion vector as motion data to header formatting and CABAC component 231 for encoding and motion to the motion compensation component 219.

Motion compensation, performed by motion compensation component 219, may involve fetching or generating the predictive block based on the motion vector determined by motion estimation component 221. Again, motion estimation component 221 and motion compensation component 219 may be functionally integrated, in some examples. Upon receiving the motion vector for the PU of the current video block, motion compensation component 219 may locate the predictive block to which the motion vector points. A residual video block is then formed by subtracting pixel values of the predictive block from the pixel values of the current video block being coded, forming pixel difference values. In general, motion estimation component 221 performs motion estimation relative to luma components, and motion compensation component 219 uses motion vectors calculated based on the luma components for both chroma components and luma components. The predictive block and residual block are forwarded to transform scaling and quantization component 213.

The partitioned video signal 201 is also sent to intra-picture estimation component 215 and intra-picture prediction component 217. As with motion estimation component 221 and motion compensation component 219, intra-picture estimation component 215 and intra-picture prediction component 217 may be highly integrated, but are illustrated separately for conceptual purposes. The intra-picture estimation component 215 and intra-picture prediction component 217 intra-predict a current block relative to blocks in a current frame, as an alternative to the inter-prediction performed by motion estimation component 221 and motion compensation component 219 between frames, as described above. In particular, the intra-picture estimation component 215 determines an intra-prediction mode to use to encode a current block. In some examples, intra-picture estimation component 215 selects an appropriate intra-prediction mode to encode a current block from multiple tested intra-prediction modes. The selected intra-prediction modes are then forwarded to the header formatting and CABAC component 231 for encoding.

For example, the intra-picture estimation component 215 calculates rate-distortion values using a rate-distortion analysis for the various tested intra-prediction modes, and selects the intra-prediction mode having the best rate-distortion characteristics among the tested modes. Rate-distortion analysis generally determines an amount of distortion (or error) between an encoded block and an original unencoded block that was encoded to produce the encoded block, as well as a bitrate (e.g., a number of bits) used to produce the encoded block. The intra-picture estimation component 215 calculates ratios from the distortions and rates for the various encoded blocks to determine which intra-prediction mode exhibits the best rate-distortion value for the block. In addition, intra-picture estimation component 215 may be configured to code depth blocks of a depth map using a depth modeling mode (DMM) based on rate-distortion optimization (RDO).

The intra-picture prediction component 217 may generate a residual block from the predictive block based on the selected intra-prediction modes determined by intra-picture estimation component 215 when implemented on an encoder or read the residual block from the bitstream when implemented on a decoder. The residual block includes the difference in values between the predictive block and the original block, represented as a matrix. The residual block is then forwarded to the transform scaling and quantization component 213. The intra-picture estimation component 215 and the intra-picture prediction component 217 may operate on both luma and chroma components.

The transform scaling and quantization component 213 is configured to further compress the residual block. The transform scaling and quantization component 213 applies a transform, such as a discrete cosine transform (DCT), a discrete sine transform (DST), or a conceptually similar transform, to the residual block, producing a video block comprising residual transform coefficient values. Wavelet transforms, integer transforms, sub-band transforms or other types of transforms could also be used. The transform may convert the residual information from a pixel value domain to a transform domain, such as a frequency domain. The transform scaling and quantization component 213 is also configured to scale the transformed residual information, for example based on frequency. Such scaling involves applying a scale factor to the residual information so that different frequency information is quantized at different granularities, which may affect final visual quality of the reconstructed video. The transform scaling and quantization component 213 is also configured to quantize the transform coefficients to further reduce bit rate. The quantization process may reduce the bit depth associated with some or all of the coefficients. The degree of quantization may be modified by adjusting a quantization parameter. In some examples, the transform scaling and quantization component 213 may then perform a scan of the matrix including the quantized transform coefficients. The quantized transform coefficients are forwarded to the header formatting and CABAC component 231 to be encoded in the bitstream.

The scaling and inverse transform component 229 applies a reverse operation of the transform scaling and quantization component 213 to support motion estimation. The scaling and inverse transform component 229 applies inverse scaling, transformation, and/or quantization to reconstruct the residual block in the pixel domain, e.g., for later use as a reference block which may become a predictive block for another current block. The motion estimation component 221 and/or motion compensation component 219 may calculate a reference block by adding the residual block back to a corresponding predictive block for use in motion estimation of a later block/frame. Filters are applied to the reconstructed reference blocks to mitigate artifacts created during scaling, quantization, and transform. Such artifacts could otherwise cause inaccurate prediction (and create additional artifacts) when subsequent blocks are predicted.

The filter control analysis component 227 and the in-loop filters component 225 apply the filters to the residual blocks and/or to reconstructed image blocks. For example, the transformed residual block from the scaling and inverse transform component 229 may be combined with a corresponding prediction block from intra-picture prediction component 217 and/or motion compensation component 219 to reconstruct the original image block. The filters may then be applied to the reconstructed image block. In some examples, the filters may instead be applied to the residual blocks. As with other components in FIG. 2, the filter control analysis component 227 and the in-loop filters component 225 are highly integrated and may be implemented together, but are depicted separately for conceptual purposes. Filters applied to the reconstructed reference blocks are applied to particular spatial regions and include multiple parameters to adjust how such filters are applied. The filter control analysis component 227 analyzes the reconstructed reference blocks to determine where such filters should be applied and sets corresponding parameters. Such data is forwarded to the header formatting and CABAC component 231 as filter control data for encoding. The in-loop filters component 225 applies such filters based on the filter control data. The filters may include a deblocking filter, a noise suppression filter, a SAO filter, and an adaptive loop filter. Such filters may be applied in the spatial/pixel domain (e.g., on a reconstructed pixel block) or in the frequency domain, depending on the example.

When operating as an encoder, the filtered reconstructed image block, residual block, and/or prediction block are stored in the decoded picture buffer component 223 for later use in motion estimation as discussed above. When operating as a decoder, the decoded picture buffer component 223 stores and forwards the reconstructed and filtered blocks toward a display as part of an output video signal. The decoded picture buffer component 223 may be any memory device capable of storing prediction blocks, residual blocks, and/or reconstructed image blocks.

The header formatting and CABAC component 231 receives the data from the various components of codec system 200 and encodes such data into a coded bitstream for transmission toward a decoder. Specifically, the header formatting and CABAC component 231 generates various headers to encode control data, such as general control data and filter control data. Further, prediction data, including intra-prediction and motion data, as well as residual data in the form of quantized transform coefficient data are all encoded in the bitstream. The final bitstream includes all information desired by the decoder to reconstruct the original partitioned video signal 201. Such information may also include intra-prediction mode index tables (also referred to as codeword mapping tables), definitions of encoding contexts for various blocks, indications of most probable intra-prediction modes, an indication of partition information, etc. Such data may be encoded by employing entropy coding. For example, the information may be encoded by employing context adaptive variable length coding (CAVLC), CABAC, syntax-based context-adaptive binary arithmetic coding (SBAC), probability interval partitioning entropy (PIPE) coding, or another entropy coding technique. Following the entropy coding, the coded bitstream may be transmitted to another device (e.g., a video decoder) or archived for later transmission or retrieval.

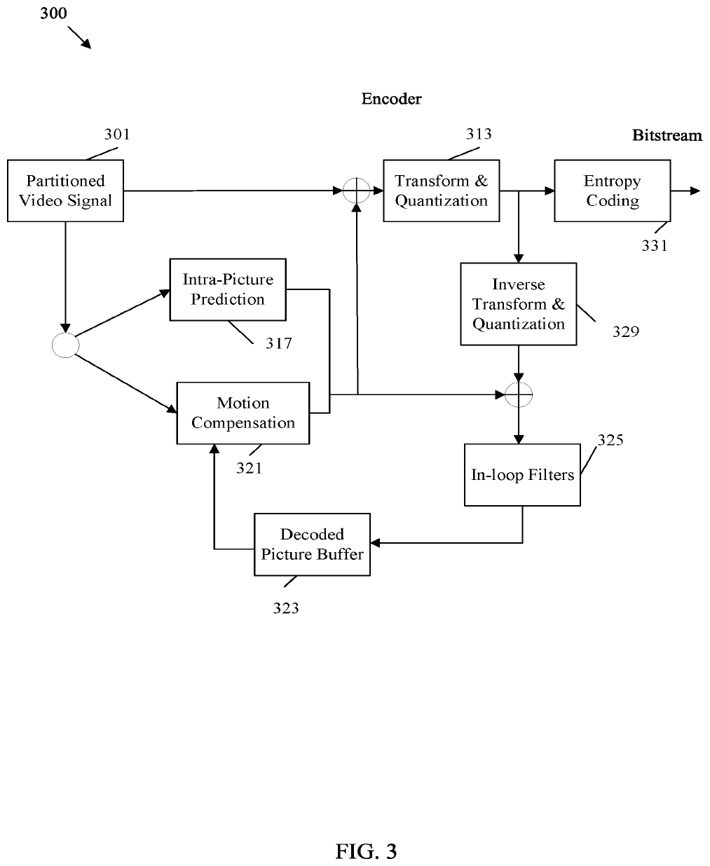

FIG. 3 is a block diagram illustrating an example video encoder 300. Video encoder 300 may be employed to implement the encoding functions of codec system 200 and/or implement steps 101, 103, 105, 107, and/or 109 of operating method 100. Encoder 300 partitions an input video signal, resulting in a partitioned video signal 301, which is substantially similar to the partitioned video signal 201. The partitioned video signal 301 is then compressed and encoded into a bitstream by components of encoder 300.

Specifically, the partitioned video signal 301 is forwarded to an intra-picture prediction component 317 for intra-prediction. The intra-picture prediction component 317 may be substantially similar to intra-picture estimation component 215 and intra-picture prediction component 217. The partitioned video signal 301 is also forwarded to a motion compensation component 321 for inter-prediction based on reference blocks in a decoded picture buffer component 323. The motion compensation component 321 may be substantially similar to motion estimation component 221 and motion compensation component 219. The prediction blocks and residual blocks from the intra-picture prediction component 317 and the motion compensation component 321 are forwarded to a transform and quantization component 313 for transform and quantization of the residual blocks. The transform and quantization component 313 may be substantially similar to the transform scaling and quantization component 213. The transformed and quantized residual blocks and the corresponding prediction blocks (along with associated control data) are forwarded to an entropy coding component 331 for coding into a bitstream. The entropy coding component 331 may be substantially similar to the header formatting and CABAC component 231.

The transformed and quantized residual blocks and/or the corresponding prediction blocks are also forwarded from the transform and quantization component 313 to an inverse transform and quantization component 329 for reconstruction into reference blocks for use by the motion compensation component 321. The inverse transform and quantization component 329 may be substantially similar to the scaling and inverse transform component 229. In-loop filters in an in-loop filters component 325 are also applied to the residual blocks and/or reconstructed reference blocks, depending on the example. The in-loop filters component 325 may be substantially similar to the filter control analysis component 227 and the in-loop filters component 225. The in-loop filters component 325 may include multiple filters as discussed with respect to in-loop filters component 225. The filtered blocks are then stored in a decoded picture buffer component 323 for use as reference blocks by the motion compensation component 321. The decoded picture buffer component 323 may be substantially similar to the decoded picture buffer component 223.

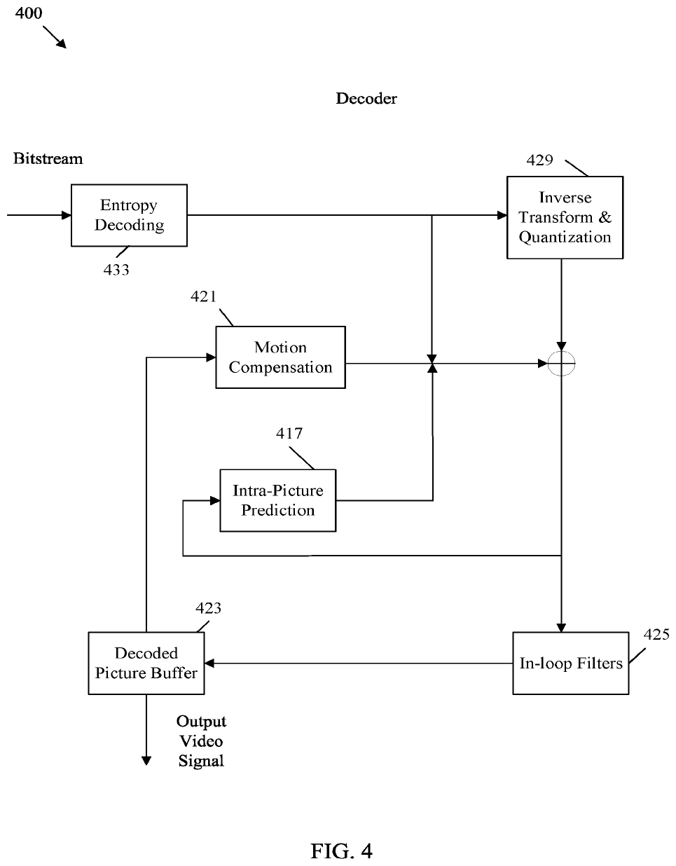

FIG. 4 is a block diagram illustrating an example video decoder 400. Video decoder 400 may be employed to implement the decoding functions of codec system 200 and/or implement steps 111, 113, 115, and/or 117 of operating method 100. Decoder 400 receives a bitstream, for example from an encoder 300, and generates a reconstructed output video signal based on the bitstream for display to an end user.

The bitstream is received by an entropy decoding component 433. The entropy decoding component 433 is configured to implement an entropy decoding scheme, such as CAVLC, CABAC, SBAC, PIPE coding, or other entropy coding techniques. For example, the entropy decoding component 433 may employ header information to provide a context to interpret additional data encoded as codewords in the bitstream. The decoded information includes any desired information to decode the video signal, such as general control data, filter control data, partition information, motion data, prediction data, and quantized transform coefficients from residual blocks. The quantized transform coefficients are forwarded to an inverse transform and quantization component 429 for reconstruction into residual blocks. The inverse transform and quantization component 429 may be similar to inverse transform and quantization component 329.

The reconstructed residual blocks and/or prediction blocks are forwarded to intra-picture prediction component 417 for reconstruction into image blocks based on intra-prediction operations. The intra-picture prediction component 417 may be similar to intra-picture estimation component 215 and an intra-picture prediction component 217. Specifically, the intra-picture prediction component 417 employs prediction modes to locate a reference block in the frame and applies a residual block to the result to reconstruct intra-predicted image blocks. The reconstructed intra-predicted image blocks and/or the residual blocks and corresponding inter-prediction data are forwarded to a decoded picture buffer component 423 via an in-loop filters component 425, which may be substantially similar to decoded picture buffer component 223 and in-loop filters component 225, respectively. The in-loop filters component 425 filters the reconstructed image blocks, residual blocks and/or prediction blocks, and such information is stored in the decoded picture buffer component 423. Reconstructed image blocks from decoded picture buffer component 423 are forwarded to a motion compensation component 421 for inter-prediction. The motion compensation component 421 may be substantially similar to motion estimation component 221 and/or motion compensation component 219. Specifically, the motion compensation component 421 employs motion vectors from a reference block to generate a prediction block and applies a residual block to the result to reconstruct an image block. The resulting reconstructed blocks may also be forwarded via the in-loop filters component 425 to the decoded picture buffer component 423. The decoded picture buffer component 423 continues to store additional reconstructed image blocks, which can be reconstructed into frames via the partition information. Such frames may also be placed in a sequence. The sequence is output toward a display as a reconstructed output video signal.

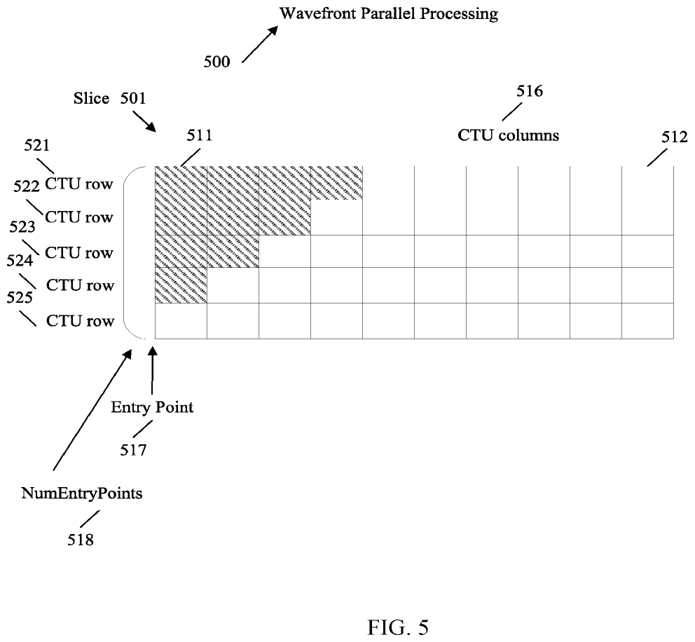

FIG. 5 is a schematic diagram illustrating an example mechanism of WPP 500. For example, WPP 500 may be employed to as part of method 100 to encode and/or decode a slice 501. As such, WPP 500 may be employed by a codec system 200, an encoder 300, and/or a decoder 400.

As shown, WPP 500 is applied to a slice 501. A slice 501 is a partition of a picture. Specifically, a picture can be partitioned into one or more slices 501. A slice 501 may contain an integer number of consecutive complete CTU rows 521, 522, 523, 524, and 525. Further, a slice 501 and all sub-divisions (e.g., CTU 511 and 512) are exclusively contained in a single NAL unit. WPP 500 may be applied when the slice 501 contains an integer number of consecutive complete CTU rows 521, 522, 523, 524, and 525. Optionally, in some examples a slice 501 may contain one or more tiles, and such tiles may each contain an integer number of consecutive complete CTU rows 521, 522, 523, 524, and 525. Accordingly, a slice 501 is defined in the VVC standard as an integer number of complete tiles or an integer number of consecutive complete CTU rows 521-525 within a tile of a picture that are exclusively contained in a single NAL unit.

The slice 501 contains CTUs 511 and 512. A CTU 511/512 is a group of samples of a predefined size that can be partitioned into coding blocks by a coding tree. For example, the CTU 511 and 512 may be arranged into CTU rows 521-525 and CTU columns 516. A CTU row 521-525 is a group of CTUs 511/512 that extend horizontally between a left boundary of the slice 501 and a right boundary of the slice 501. A CTU column 516 is a group of CTUs 511/512 that extend vertically between atop boundary of the slice 501 and a bottom boundary of the slice 501.

WPP 500 may employ multiple computing threads operating in parallel to code CTUs 511/512. In the example shown, CTUs 511 have already been coded and CTUs 512 have not been coded yet. For example, a first thread may begin coding CTU row 521 at a first time. Once a CTU 511 has been coded in the first CTU row 521, a second thread may begin coding CTU row 522. Once a CTU 511 has been coded in the second CTU row 522, a third thread may begin coding CTU row 523. Once a CTUs 511 has been coded in the third CTU row 523, a fourth thread may begin coding CTU row 524. Once a CTU 511 has been coded in the fourth CTU row 524, a fifth thread may begin coding a fifth CTU row 525. This results in the pattern as shown in FIG. 5. Additional threads may be employed as desired. This mechanism creates a pattern with a wavefront like appearance, and hence the name of WPP 500. Some video coding mechansims code a current CTU 512 based on a coded CTU 511 positioned above or to the left of the of the current CTU 512. WPP 500 leaves a CTU 511 coding delay between initiating each thread to ensure such CTUs 511 have already been coded upon reaching any current CTU 512 to be coded. It should be noted that a system employing the VVC standard may employ a one CTU 511 coding delay, while other systems, such as HEVC, may employ a two CTU 511 coding delay. Any other CTU 511 coding delay value may also be employed within the scope of the present disclosure.

The CTUs 511 are coded into a bitstream in CTU rows 521-525. For example, CTU row 521 may be included in the bitstream, followed by CTU row 522, followed by CTU row 523, followed by CTU row 524, followed by CTU row 525, etc. Each CTU row 521-525 may be an independently addressable subset of the slice 501 in the bitstream. For example, each CTU row 521-525 can be addressed at an entry point 517. An entry point 517 is a bit location in the bitstream containing a first bit of video data for a corresponding subset of the slice 501 after the slice 501 is encoded. When WPP 500 is employed, the entry point 517 is the bit location containing the first bit of the corresponding CTU row 521-525. For example, an entry point 517 for CTU row 523 includes a first bit of video data for CTU row 523 and is positioned after the last bit of video data for CTU row 522. As such, a number of entry points (NumEntryPoints) 518 is a number of the entry points 517 for the CTU rows 521-525.

In some video coding systems, bit offsets for the entry points 517 can be signaled in an array in a slice header associated with the slice 501. Further, the encoder can determine the NumEntryPoints 518 and signals such data in the slice header, for example in a num_entry_point_offsets parameter. The decoder can then employ the number of the entry points 517 to determine how many bit offsets should be obtained from the array to obtain all of the relevant entry points 517 to begin decoding. The num_entry_point_offsets parameter contains multiple bits and is signaled in each slice header. Since each picture may contain several slices 501 and the video sequence may contain thousands of pictures, the num_entry_point_offsets is signaled many times and may have a significant aggregate impact on the amount of data in a video sequence.

The present disclosure includes various mechanisms to derive the NumEntryPoints 518 at a decoder (and/or an HRD at an encoder) without signaling such data in the bitstream. Hence, num_entry_point_offsets can be omitted from the bitstream, which significantly increases overall bitstream compression. For example, the mechanisms may be employed to derive the NumEntryPoints 518 for a slice 501 when the slice 501 is coded according to WPP 500. The NumEntryPoints 518 may be derived based on a size of the CTU rows 521-525, based on a size of the CTU columns 516, based on a number of CTUs 511/512 in the slice 501, and/or based on CTU 511/512 and/or slice 501 addresses.

For example, NumEntryPoints 518 can be derived as follows:

```
if( !entropy_coding_sync_enabled_flag )
  NumEntryPoints = NumBricksInCurrSlice − 1
else {
  for( numBrickSpecificCtuRowsInSlice = 0, i =0; i < NumBricksInCurrSlice; i++ )
    numBrickSpecificCtuRowsInSlice += BrickHeight[ SliceBrickIdx[ i ] ]
  NumEntryPoints = numBrickSpecificCtuRowsInSlice − 1
}
```

where !entropy_coding_sync_enabled_flag indicates WPP 500 is not in use, NumBricksInCurrSlice is a number of tiles in a slice 501, numBrickSpecificCtuRowsInSlice is a number of CTU rows 521-525 in the slice 501, and BrickHeight[SliceBrickIdx[i]] is a height of the CTU rows 521-525 (and hence the height of a CTU column 516). It should be noted that entropy_coding_sync_enabled_flag may be employed to indicate whether WPP 500 is used to code a slice 501. For example, an entropy_coding_sync_enabled_flag may be set to one when WPP 500 is employed and set to zero when WPP 500 is not employed. In some coding systems, ! indicates a not value. As such, !entropy_coding_sync_enabled_flag indicates WPP 500 is not in use for the if clause of the abovementioned pseudocode. Hence, WPP is in use for the else clause of the abovementioned pseudocode.

The example checks whether the slice 501 employs WPP 500. If WPP 500 is not employed, NumEntryPoints 518 is one less than the number of tiles in the slice 501. Otherwise, WPP 500 is used. In such a case, the example determines the number of CTU rows 521-525 by adding up the height of each of the CTU rows 521-525 as compared to the height of the slice 501 (and hence the height of the CTU columns 516). The NumEntryPoints 518 is one less than the number of CTU rows 521-525.

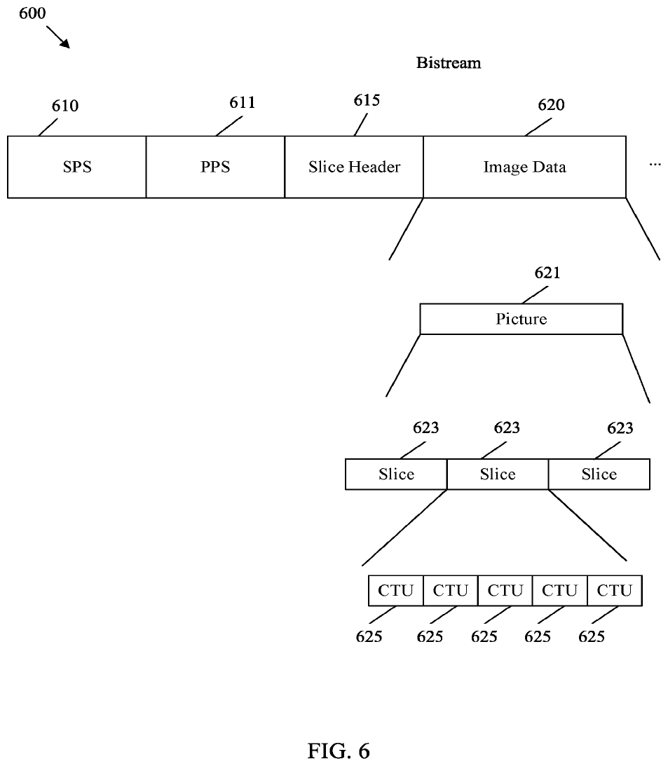

FIG. 6 is a schematic diagram illustrating an example bitstream 600. For example, the bitstream 600 can be generated by a codec system 200 and/or an encoder 300 for decoding by a codec system 200 and/or a decoder 400 according to method 100. Further, the bitstream 600 may include slices 501 coded according to WPP 500.

The bitstream 600 includes a SPS 610, a plurality of picture parameter sets (PPSs) 611, a plurality of slice headers 615, and image data 620. An SPS 610 contains sequence data common to all the pictures in the coded video sequence contained in the bitstream 600. Such data can include picture sizing, bit depth, coding tool parameters, bit rate restrictions, etc. The PPS 611 contains parameters that apply to an entire picture. Hence, each picture in the video sequence may refer to a PPS 611. It should be noted that, while each picture refers to a PPS 611, a single PPS 611 can contain data for multiple pictures in some examples. For example, multiple similar pictures may be coded according to similar parameters. In such a case, a single PPS 611 may contain data for such similar pictures. The PPS 611 can indicate coding tools available for slices in corresponding pictures, quantization parameters, offsets, etc. The slice header 615 contains parameters that are specific to each slice in a picture. Hence, there may be one slice header 615 per slice in the video sequence. The slice header 615 may contain slice type information, POCs, reference picture lists, prediction weights, tile entry points, deblocking parameters, etc. It should be noted that a slice header 615 may also be referred to as a tile group header in some contexts.

The image data 620 contains video data encoded according to inter-prediction and/or intra-prediction as well as corresponding transformed and quantized residual data. For example, a video sequence includes a plurality of pictures 621. A picture 621 is a complete image that is intended for complete or partial display to a user at a corresponding instant in a video sequence. A picture 621 may be contained in a single access unit (AU). A picture 621 contains one or more slices 623. A slice 623 may be defined as an integer number of complete tiles or an integer number of consecutive complete CTU rows (e.g., within a tile) of a picture 621 that are exclusively contained in a single NAL unit. For example, a slice 623 may be substantially similar to slice 501. The slices 623 are further divided into CTUs 625 and/or coding tree blocks (CTBs). A CTU 625 is a group of samples of a predefined size that can be partitioned by a coding tree. For example, a CTU 625 in a bitstream 600 has been encoded, and hence may be substantially similar to CTUs 511. A CTB is a subset of a CTU 625 and contains luma components or chroma components of the CTU. The CTUs 625/CTBs are further divided into coding blocks based on coding trees. The coding blocks can then be encoded/decoded according to prediction mechanisms.

As noted above, the NumEntryPoints 518 can be determined at a decoder. Accordingly, the slice header 615 does not contain a num_entry_point_offsets parameter or other parameter indicating a value of NumEntryPoints 518. As num_entry_point_offsets is removed from each slice header 615, the bitstream 600 is compressed. This reduces memory and network resource usage at both an encoder and a decoder.

The preceding information is now described in more detail herein below. In a video codec specification, pictures should be identified for multiple purposes. These include for use as reference pictures in inter prediction, for output of pictures from the DPB, for scaling of motion vectors, for weighted prediction, etc. For example, pictures can be identified by picture order count (POC). In some video coding systems, pictures in the DPB can be marked as used for short-term reference, used for long-term reference, or unused for reference. Once a picture has been marked unused for reference, the picture can no longer be used for prediction. When such a picture is no longer needed for output, the picture can be removed from the DPB.

Some video coding systems employ short-term and long-term reference pictures. A reference picture may be marked as unused for reference when the picture is no longer needed for use as a prediction reference. The conversion of a picture between these three statuses (e.g., short-term, long-term, and unused for reference) may be controlled by a decoded reference picture marking process. For example, an implicit sliding window process and/or an explicit memory management control operation (MMCO) process may be employed for marking reference pictures. The sliding window process marks a short-term reference picture as unused for reference when the number of reference frames is equal to a maximum number of reference frames (max_num_ref frames) which may be stored in the SPS. The short-term reference pictures may be stored in a first-in, first-out manner so that the most recently decoded short-term pictures are kept in the DPB. The explicit MMCO process may include multiple MMCO commands. An MMCO command may mark one or more short-term or long-term reference picture as unused for reference, mark all the pictures as unused for reference, or mark the current reference picture or an existing short-term reference picture as long-term and assign a long-term picture index to that long-term reference picture. In some video coding systems, the reference picture marking operations as well as the processes for output and removal of pictures from the DPB are performed after a picture has been decoded.

Other video coding systems employ a reference picture set (RPS) for reference picture management. One difference between the RPS process and the MMCO/sliding window process is that a complete set of the reference pictures that are used by the current picture or any subsequent picture is provided for each slice. Thus, a complete set of all pictures that should be kept in the DPB for use by the current or future picture is signaled. This is different from schemes that signal only relative changes to the DPB. The RPS mechanism does not need to maintain information from earlier pictures in decoding order in order to maintain the correct status of reference pictures in the DPB. Corresponding changes in picture decoding and DPB operations may be employed to exploit the advantages of RPS and improve error resilience. In some video coding systems picture marking and buffer operations, including both output and removal of decoded pictures from the DPB, may be applied after a current picture has been decoded. In other video coding systems, the RPS is first decoded from a slice header of the current picture. Then, picture marking and buffer operations are generally applied before decoding the current picture.

Other video coding systems manage reference pictures based on two reference picture lists denoted as reference picture list 0 and reference picture list 1. In this approach, reference picture lists for a picture may be directly constructed without using a reference picture list initialization process and a reference picture list modification process. Furthermore, reference picture marking is performed directly based on the two reference picture lists. An example reference picture management related syntax and semantics are as follows.

An example sequence parameter set RBSP syntax is as follows.

| | Descriptor |
|---|---|
| seq_parameter_set_rbsp( ) { | |
| ... | |
| log2_max_pic_order_cnt_lsb_minus4 | ue(v) |
| sps_max_dec_pic_buffering_minus1 | ue(v) |
| long_term_ref_pics_flag | u(1) |
| sps_idr_rpl_present_flag | u(1) |
| rpl1_same_as_rpl0_flag | u(1) |
| for( i = 0; i < !rpl1_same_as_rpl0_flag ? 2 : | |
| 1; i++ ) { | |
| num_ref_pic_lists_in_sps[ i ] | ue(v) |
| for( j = 0; j < num_ref_pic_lists_in_sps[ i ]; | |
| j++) | |
| ref_pic_list_struct( i, j ) | |
| } | |
| ... | |

An example picture parameter set RBSP syntax is as follows.

| | Descriptor |
|---|---|
| pic_parameter_set_rbsp( ) { | |
| ... | |
| for( i = 0; i < 2; i++ ) | |
| num_ref_idx_default_active_minus1[ i ] | ue(v) |
| rpl1_idx_present_flag | u(1) |
| ... | |

An example of general slice header syntax is as follows.

| | Descriptor |
|---|---|
| slice_header( ) { | |
| ... | |
| slice_pic_order_cnt_lsb | u(v) |
| if( ( NalUnitType != IDR_W_RADL && | |
| NalUnitType != IDR_N_LP ) | |
| \| \| sps_idr_rpl_present_flag ) { | |
| for( i = 0; i < 2; i++ ) { | |
| if( num_ref_pic_lists_in_sps[ i ] > 0 && | |
| ( i == 0 \| \| ( i == 1 && | |
| rpl1_idx_present_flag ) ) ) | |
| ref_pic_list_sps_flag[ i ] | u(1) |
| if( ref_pic_list_sps_flag[ i ] ) { | |
| if( num_ref_pic_lists_in_sps[ i ] > 1 && | |
| ( i = = 0 \| \| ( i == 1 && | |
| rpl1_idx_present_flag ) ) ) | |
| ref_pic_list_idx[ i ] | u(v) |
| } else | |
| ref_pic_list_struct( i, num_ref_pic_lists_in_sps[ i ] ) | |
| for(j = 0; j < NumLtrpEntries[ i ][ RplsIdx[ i ] ]; | |
| j++ ) { | |
| if( ltrp_in_slice_header_flag[ i ][ RplsIdx[ i ] ] ) | |
| slice_poc_lsb_lt[ i ][ j ] | u(v) |
| delta_poc_msb_present_flag[ i ][ j ] | u(1) |
| if( delta_poc_msb_present_flag[ i ][ j ] ) | |
| delta_poc_msb_cycle_lt[ i ][ j ] | ue(v) |
| } | |
| } | |
| if( ( slice_type != I && num_ref_entries[ 0 ][ | |
| RplsIdx[ 0 ] ] > 1) \| \| | |
| ( slice_type == B && num_ref_entries[ 1 ][ | |
| RplsIdx[ 1 ] ] > 1 ) ) { | |
| num_ref_idx_active_override_flag | u(1) |
| if( num_ref_idx_active_override_flag ) | |
| for( i = 0; i < ( slice_type == B ? 2: 1 ); i++ ) | |
| if( num_ref_entries[ i ][ RplsIdx[ i ] ] > 1 ) | |
| num_ref_idx_active_minus1[ i ] | ue(v) |
| } | |
| } | |
| ... | |

An example reference picture list structure syntax is as follows.

| | Descriptor |
|---|---|
| ref_pic_list_struct( listIdx, rplsIdx ) { | |
| num_ref_entries[ listIdx ][ rplsIdx ] | ue(v) |
| if( long_term_ref_pics_flag ) | |
| ltrp_in_slice_header_flag[ listIdx ][ rplsIdx ] | u(1) |
| for( i = 0, j = 0; i < num_ref_entries[ listIdx ][ | |
| rplsIdx ]; i++ ) { | |
| if( long_term_ref_pics_flag ) | |
| st_ref_pic_flag[ listIdx ][ rplsIdx ][ i ] | u(1) |
| if( st_ref_pic_flag[ listIdx ][ rplsIdx ][ i ] ) { | |
| abs_delta_poc_st[ listIdx ][ rplsIdx ][ i ] | ue(v) |
| if( abs_delta_poc_st[ listIdx ][ rplsIdx ][ i ] > 0 ) | |
| strp_entry_sign_flag[ listIdx ][ rplsIdx ][ i ] | u(1) |
| } else if( !ltrp_in_slice_header_flag[ listIdx ][ | |
| rplsIdx ] ) | |
| rpls_poc_lsb_lt[ listIdx ][ rplsIdx ][ j++ ] | u(v) |
| } | |
| } | |

An example sequence parameter set RBSP semantics is as follows. A log2_max_pic_order_cnt_lsb_minus4 specifies the value of the variable MaxPicOrderCntLsb that is used in the decoding process for picture order count as follows:

MaxPicOrderCntLsb=2^{(log2_max_pic_order_cnt_lsb_minus4+4)} (7-7)

The value of log2_max_pic_order_cnt_lsb_minus4 may be in the range of zero to twelve, inclusive. The sps_max_dec_pic_buffering_minus1 plus 1 specifies the maximum required size of the decoded picture buffer for the CVS in units of picture storage buffers. The value of sps_max_dec_pic_buffering_minus1 may be in the range of zero to MaxDpbSize−1, inclusive, where MaxDpbSize is as specified somewhere else. The long_term_ref_pics_flag may be set equal to zero to specify that no long-term reference picture (LTRP) is used for inter-prediction of any coded picture in the CVS. The long_term_ref_pics_flag may be set equal to one to specify that LTRPs may be used for inter-prediction of one or more coded pictures in the CVS. The sps_idr_rpl_present_flag may be set equal to one to specify that reference picture list syntax elements are present in slice headers of IDR pictures. The sps_idr_rpl_present_flag may be set equal to zero to specify that reference picture list syntax elements are not present in slice headers of IDR pictures.

The rpl1_same_as_rpl0_flag may be set equal to one to specify that the syntax structures num_ref_pic_lists_in_sps[1] and ref_pic_list_struct(1, rplsIdx) are not present and the following applies. The value of num_ref_pic_lists_in_sps[1] is inferred to be equal to the value of num_ref_pic_lists_in_sps[0]. The value of each syntax element in ref_pic_list_struct(1, rplsIdx) is inferred to be equal to the value of corresponding syntax element in ref_pic_list_struct(0, rplsIdx) for rplsIdx ranging from zero to num_ref_pic_lists_in_sps[0]−1. The num_ref_pic_lists_in_sps[i] specifies the number of the ref_pic_list_struct(listIdx, rplsIdx) syntax structures with listIdx equal to i included in the SPS. The value of num_ref_pic_lists_in_sps[i] may be in the range of zero to sixty four, inclusive. For each value of listIdx (equal to zero or one), a decoder should allocate memory for a total number of num_ref_pic_lists_in_sps[i]+1 ref_pic_list_struct(listIdx, rplsIdx) syntax structures since there may be one ref_pic_list_struct(listIdx, rplsIdx) syntax structure directly signaled in the slice headers of a current picture.

An example picture parameter set RBSP semantics are as follows. The num_ref_idx_default_active_minus1[i] plus 1, when i is equal to zero, specifies the inferred value of the variable NumRefIdxActive[0] for P or B slices with num_ref_idx_active_override_flag equal to zero, and, when i is equal to 1, specifies the inferred value of NumRefIdxActive[1] for B slices with num_ref_idx_active_override_flag equal to zero. The value of num_ref_idx_default_active_minus1[i] should be in the range of zero to fourteen, inclusive. The rpl1_idx_present_flag may be set equal to zero to specify that ref_pic_list_sps_flag[1] and ref_pic_list_idx[1] are not present in slice headers. The rpl1_idx_present_flag may be set equal to one to specify that ref_pic_list_sps_flag[1] and ref_pic_list_idx[1] may be present in slice headers.

An example of general slice header semantics is as follows. The slice_pic_order_cnt_lsb specifies the picture order count modulo MaxPicOrderCntLsb for the current picture. The length of the slice_pic_order_cnt_lsb syntax element is log2_max_pic_order_cnt_lsb_minus4+4 bits. The value of the slice_pic_order_cnt_lsb should be in the range of zero to MaxPicOrderCntLsb−1, inclusive. The ref_pic_list_sps_flag[i] may be set equal to one to specify that reference picture list i of the current slice is derived based on one of the ref_pic_list_struct(listIdx, rplsIdx) syntax structures with listIdx equal to i in the active SPS. The ref_pic_list_sps_flag[i] may be set equal to zero to specify that reference picture list i of the current slice is derived based on the ref_pic_list_struct(listIdx, rplsIdx) syntax structure with listIdx equal to i that is directly included in the slice headers of the current picture. When num_ref_pic_lists_in_sps[i] is equal to zero, the value of ref_pic_list_sps_flag[i] is inferred to be equal to zero. When rpl1_idx_present_flag is equal to zero, the value of ref_pic_list_sps_flag[1] is inferred to be equal to ref_pic_list_sps_flag[0].

The ref_pic_list_idx[i] specifies the index, into the list of the ref_pic_list_struct(listIdx, rplsIdx) syntax structures with listIdx equal to i included in the active SPS, of the ref_pic_list_struct(listIdx, rplsIdx) syntax structure with listIdx equal to i that is used for derivation of reference picture list i of the current picture. The syntax element ref_pic_list_idx[i] is represented by Ceil(Log2(num_ref_pic_lists_in_sps[i])) bits. When not present, the value of ref_pic_list_idx[i] is inferred to be equal to zero. The value of ref_pic_list_idx[i] shall be in the range of zero to num_ref_pic_lists_in_sps[i]−1, inclusive. When ref_pic_list_sps_flag[i] is equal to one and num_ref_pic_lists_in_sps[i] is equal to one, the value of ref_pic_list_idx[i] is inferred to be equal to zero. When ref_pic_list_sps_flag[i] is equal to one and rpl1_idx_present_flag is equal to zero, the value of ref_pic_list_idx[1] is inferred to be equal to ref_pic_list_idx[0 ].

The variable RplsIdx[i] is derived as follows:

RplsIdx[i]=ref_pic_list_sps_flag[i]?ref_pic_list_idx[i]:num_ref_pic_lists_in_sps[i] (7-40)

The slice_poc_lsb_lt[i][j] specifies the value of the picture order count modulo MaxPicOrderCntLsb of the j-th LTRP entry in the i-th reference picture list. The length of the slice_poc_lsb_lt[i][j] syntax element is log2_max_pic_order_cnt_lsb_minus4+4 bits.

The variable PocLsbLt[i][j] is derived as follows:

PocLsbLt[i][j]=ltrp_in_slice_header_flag[i][RplsIdx[i]]?slice_poc_lsb_lt[i][j]:rpls_poc_lsb_lt[listIdx][RplsIdx[i]][j] (7-41)

The delta_poc_msb_present_flag[i][j] may be set equal to one to specify that delta_poc_msb_cycle_lt[i][j] is present. The delta_poc_msb_present_flag[i][j] may be set equal to zero to specify that delta_poc_msb_cycle_lt[i][j] is not present. Let prevTid0Pic be the previous picture in decoding order that has TemporalId equal to zero and is not a random access skipped leading (RASL) or random access decodable leading (RADL) picture. Let setOfPrevPocVals be a set including the following: the PicOrderCntVal of prevTid0Pic; the PicOrderCntVal of each picture referred to by entries in RefPicList[0] and entries in RefPicList[1] of prevTid0Pic; and the PicOrderCntVal of each picture that follows prevTid0Pic in decoding order and precedes the current picture in decoding order. When there is more than one value in setOfPrevPocVals for which the value modulo MaxPicOrderCntLsb is equal to PocLsbLt[i][j], the value of delta_poc_msb_present_flag[i][j] should be equal to one.

The delta_poc_msb_cycle_lt[i][j] specifies the value of the variable FullPocLt[i][j] as follows:

if( j == 0 )
deltaMsbCycle[ i ][ j ] = delta_poc_msb_cycle_lt[ i ][ j ]

| | |
|---|---|
| else | (7-42) |

deltaMsbCycle[ i ][ j ] = delta_poc_msb_cycle_lt[ i ][ j ] + deltaMsbCycle[ i ][ j − 1 ]
FullPocLt[ i ][ RplsIdx[ i ] ][ j ] = PicOrderCntVal − deltaMsbCycle[ i ][ j ] *
MaxPicOrderCntLsb −
( PicOrderCntVal & ( MaxPicOrderCntLsb − 1 ) ) + PocLsbLt[ i ][ j ]

The value of delta_poc_msb_cycle_lt[i][j] should be in the range of zero to 2(32−log2_max_pic_order_cnt_lsb_minus4−4), inclusive. When not present, the value of delta_poc_msb_cycle_lt[i][j] is inferred to be equal to zero. The num_ref_idx_active_override_flag may be set equal to one to specify that the syntax element num_ref_idx_active_minus1[0] is present for P and B slices and that the syntax element num_ref_idx_active_minus1[1] is present for B slices. The num_ref_idx_active_override_flag may be set equal to zero to specify that the syntax elements num_ref_idx_active_minus1[0] and num_ref_idx_active_minus1[1] are not present. When not present, the value of num_ref_idx_active_override_flag is inferred to be equal to one. The num_ref_idx_active_minus1[i] is used for the derivation of the variable NumRefIdxActive[i]. The value of num_ref_idx_active_minus1[i] may be in the range of zero to fourteen, inclusive. For i equal to zero or one, when the current slice is a B slice, num_ref_idx_active_override_flag is equal to one, and num_ref_idx_active_minus1[i] is not present, num_ref_idx_active_minus1[i] is inferred to be equal to zero. When the current slice is a P slice, num_ref_idx_active_override_flag is equal to one, and num_ref_idx_active_minus1[0] is not present, num_ref_idx_active_minus1[0] is inferred to be equal to zero.

The variable NumRefIdxActive[i] is derived as follows:

for( i = 0; i < 2; i++ ) {
if( slice_type == B | | ( slice_type == P && i == 00 ) ) {
if( num_ref_idx_active_override_flag )

| | |
|---|---|
| NumRefIdxActive[ i ] = num_ref_idx_active_minus1[ i ] + 1 | (7-43) |

```
  else {
    if( num_ref_entries[ i ][ RplsIdx[ i ] ] >=
num_ref_idx_default_active_minus1[ i ] + 1 )
      NumRefIdxActive[ i ] = num_ref_idx_default_active_minus1[ i ] + 1
    else
      NumRefIdxActive[ i ] = num_ref_entries[ i ][ RplsIdx[ i ] ]
  }
} else // slice_type == I | | ( slice_type == P && i == 1 )
  NumRefIdxActive[ i ] = 0
}
```

The value of NumRefIdxActive[i]−1 specifies the maximum reference index for reference picture list i that may be used to decode the slice. When the value of NumRefIdxActive[i] is equal to zero, no reference index for reference picture list i may be used to decode the slice. The variable CurrPicIsOnlyRef, which specifies that the current decoded picture is the only reference picture for the current slice, is derived as follows:

CurrPicIsOnlyRef=sps_cpr_enabled_flag&&(slice_type==P)&&(num_ref_idx_active_minus1[0]==0) (7-44)

An example reference picture list structure semantics is as follows. The ref_pic_list_struct(listIdx, rplsIdx) syntax structure may be present in an SPS or in a slice header. Depending on whether the syntax structure is included in a slice header or an SPS, the following applies. If present in a slice header, the ref_pic_list_struct(listIdx, rplsIdx) syntax structure specifies reference picture list listIdx of the current picture (e.g., the picture containing the slice). Otherwise (e.g., present in an SPS), the ref_pic_list_struct(listIdx, rplsIdx) syntax structure specifies a candidate for reference picture list listIdx, and the term the current picture in the semantics refers to each picture that 1) has one or more slices containing ref_pic_list_idx[listIdx] equal to an index into the list of the ref_pic_list_struct(listIdx, rplsIdx) syntax structures included in the SPS, and 2) is in a CVS that has the SPS as the active SPS.

The num_ref_entries[listIdx][rplsIdx] specifies the number of entries in the ref_pic_list_struct(listIdx, rplsIdx) syntax structure. The value of num_ref_entries[listIdx][rplsIdx] should be in the range of 0 to sps_max_dec_pic_buffering_minus1+fourteen, inclusive. The ltrp_in_slice_header_flag[listIdx][rplsIdx] may be set equal to zero to specify that the POC LSBs of the LTRP entries in the ref_pic_list_struct(listIdx, rplsIdx) syntax structure are present in the ref_pic_list_struct(listIdx, rplsIdx) syntax structure. The ltrp_in_slice_header_flag[listIdx][rplsIdx] may be set equal to one to specify that the POC LSBs of the LTRP entries in the ref_pic_list_struct(listIdx, rplsIdx) syntax structure are not present in the ref_pic_list_struct(listIdx, rplsIdx) syntax structure. The st_ref_pic_flag[listIdx][rplsIdx][i] may be set equal to one to specify that the i-th entry in the ref_pic_list_struct(listIdx, rplsIdx) syntax structure is a short term reference picture (STRP) entry. The st_ref_pic_flag[listIdx][rplsIdx][i] may be set equal to zero to specify that the i-th entry in the ref_pic_list_struct(listIdx, rplsIdx) syntax structure is an LTRP entry. When not present, the value of st_ref_pic_flag[listIdx][rplsIdx][i] is inferred to be equal to one.

The variable NumLtrpEntries[listIdx][rplsIdx] may be derived as follows.

for(i=0, NumLtrpEntries[listIdx][rplsIdx]=0; i<num_ref_entries[listIdx][rplsIdx]; i++)if(!st_ref_pic_flag[listIdx][rplsIdx][i])NumLtrpEntries[listIdx][rplsIdx]++ (7-86)

The abs_delta_poc_st[listIdx][rplsIdx][i], when the i-th entry is the first STRP entry in ref_pic_list_struct(listIdx, rplsIdx) syntax structure, specifies the absolute difference between the picture order count values of the current picture and the picture referred to by the i-th entry, or, when the i-th entry is an STRP entry but not the first STRP entry in the ref_pic_list_struct(listIdx, rplsIdx) syntax structure, specifies the absolute difference between the picture order count values of the pictures referred to by the i-th entry and by the previous STRP entry in the ref_pic_list_struct(listIdx, rplsIdx) syntax structure. The value of abs_delta_poc_st[listIdx][rplsIdx][i] may be in the range of zero to 2¹⁵−1, inclusive. The strp_entry_sign_flag[listIdx][rplsIdx][i] may be set equal to one to specify that i-th entry in the syntax structure ref_pic_list_struct(listIdx, rplsIdx) has a value greater than or equal to zero. The strp_entry_sign_flag[listIdx][rplsIdx] may be set equal to zero to specify that the i-th entry in the syntax structure ref_pic_list_struct(listIdx, rplsIdx) has a value less than zero. When not present, the value of strp_entry_sign_flag[i][j] is inferred to be equal to one.

The list DeltaPocSt[listIdx][rplsIdx] is derived as follows:

| for( i = 0; i < num_ref_entries[ listIdx ][ rplsIdx ]; i++ ) { | |
|---|---|
| if( st_ref_pic_flag[ listIdx ][ rplsIdx ][ i ] ) { | (7-87) |

```
    DeltaPocSt[ listIdx ][ rplsIdx ][ i ] =
( strp_entry_sign_flag[ listIdx ][ rplsIdx ][ i ]) ?
      abs_delta_poc_st[ listIdx ][ rplsIdx ][ i ] : 0 −
abs_delta_poc_st[ listIdx ][ rplsIdx ][ i ]
}
}
```

The rpls_poc_lsb_lt[listIdx][rplsIdx][i] specifies the value of the picture order count modulo MaxPicOrderCntLsb of the picture referred to by the i-th entry in the ref_pic_list_struct(listIdx, rplsIdx) syntax structure. The length of the rpls_poc_lsb_lt[listIdx][rplsIdx][i]syntax element is log2_max_pic_order_cnt_lsb_minus4+4 bits.

In order to code a video image, the image is first partitioned, and the partitions are coded into a bitstream. Various picture partitioning schemes are available. For example, an image can be partitioned into regular slices, dependent slices, tiles, and/or according to Wavefront Parallel Processing (WPP). For simplicity, HEVC restricts encoders so that only regular slices, dependent slices, tiles, WPP, and combinations thereof can be used when partitioning a slice into groups of CTBs for video coding. Such partitioning can be applied to support Maximum Transfer Unit (MTU) size matching, parallel processing, and reduced end-to-end delay. MTU denotes the maximum amount of data that can be transmitted in a single packet. If a packet payload is in excess of the MTU, that payload is split into two packets through a process called fragmentation.

A regular slice, also referred to simply as a slice, is a partitioned portion of an image that can be reconstructed independently from other regular slices within the same picture, notwithstanding some interdependencies due to loop filtering operations. Each regular slice is encapsulated in its own Network Abstraction Layer (NAL) unit for transmission. Further, in-picture prediction (intra sample prediction, motion information prediction, coding mode prediction) and entropy coding dependency across slice boundaries may be disabled to support independent reconstruction. Such independent reconstruction supports parallelization. For example, regular slice based parallelization employs minimal inter-processor or inter-core communication. However, as each regular slice is independent, each slice is associated with a separate slice header. The use of regular slices can incur a substantial coding overhead due to the bit cost of the slice header for each slice and due to the lack of prediction across the slice boundaries. Further, regular slices may be employed to support matching for MTU size requirements. Specifically, as a regular slice is encapsulated in a separate NAL unit and can be independently coded, each regular slice should be smaller than the MTU in MTU schemes to avoid breaking the slice into multiple packets. As such, the goal of parallelization and the goal of MTU size matching may place contradicting demands to a slice layout in a picture.

Dependent slices are similar to regular slices, but have shortened slice headers and allow partitioning of the image treeblock boundaries without breaking in-picture prediction. Accordingly, dependent slices allow a regular slice to be fragmented into multiple NAL units, which provides reduced end-to-end delay by allowing a part of a regular slice to be sent out before the encoding of the entire regular slice is complete.

A tile is a partitioned portion of an image created by horizontal and vertical boundaries that create columns and rows of tiles. Tiles may be coded in raster scan order (right to left and top to bottom). The scan order of CTBs is local within a tile. Accordingly, CTBs in a first tile are coded in raster scan order, before proceeding to the CTBs in the next tile. Similar to regular slices, tiles break in-picture prediction dependencies as well as entropy decoding dependencies. However, tiles may not be included into individual NAL units, and hence tiles may not be used for MTU size matching. Each tile can be processed by one processor/core, and the inter-processor/inter-core communication employed for in-picture prediction between processing units decoding neighboring tiles may be limited to conveying a shared slice header (when adjacent tiles are in the same slice), and performing loop filtering related sharing of reconstructed samples and metadata. When more than one tile is included in a slice, the entry point byte offset for each tile other than the first entry point offset in the slice may be signaled in the slice header. For each slice and tile, at least one of the following conditions should be fulfilled: 1) all coded treeblocks in a slice belong to the same tile; and 2) all coded treeblocks in a tile belong to the same slice.

In WPP, the image is partitioned into single rows of CTBs. Entropy decoding and prediction mechanisms may use data from CTBs in other rows. Parallel processing is made possible through parallel decoding of CTB rows. For example, a current row may be decoded in parallel with a preceding row. However, decoding of the current row is delayed from the decoding process of the preceding rows by one or two CTBs, depending on the example. This delay ensures that data related to the CTB above and the CTB above and to the right of the current CTB in the current row is available before the current CTB is coded. This approach appears as a wavefront when represented graphically. This staggered start allows for parallelization with up to as many processors/cores as the image contains CTB rows. Because in-picture prediction between neighboring treeblock rows within a picture is permitted, the inter-processor/inter-core communication to enable in-picture prediction can be substantial. The WPP partitioning does consider NAL unit sizes. Hence, WPP does not support MTU size matching. However, regular slices can be used in conjunction with WPP, with certain coding overhead, to implement MTU size matching as desired.

In an example, a video coding system may partition images with slices, tiles, bricks, and WPP. A picture can be divided into one or more tile rows and one or more tile columns. A tile can be a sequence of CTUs that covers a rectangular region of a picture. A tile can be divided into one or more bricks, each of which includes a number of CTU rows within the tile. A tile that is not partitioned into multiple bricks may also be referred to as a brick. A brick that is a true subset of a tile may not be referred to as a tile. A slice may contain a number of tiles of a picture or a number of bricks of a tile. Two modes of slices may be supported, including raster-scan slice mode and the rectangular slice mode. In the raster-scan slice mode, a slice contains a sequence of tiles in a tile raster scan of a picture. In rectangular slice mode, a slice may contain a number of bricks of a picture that collectively form a rectangular region of the picture. The bricks within a rectangular slice are in an order of brick raster scan of the slice. A single_tile_in_pic_flag may be set equal to one to specify that there is only one tile a picture and the single tile is not divided into bricks. An entropy_coding_sync_enabled_flag may be set equal to one to specify that WPP is in use.

An example picture parameter set RBSP syntax is as follows:

| | Descriptor |
|---|---|
| pic_parameter_set_rbsp( ) { | |
| ... | ue(v) |
| single_tile_in_pic_flag | u(1) |
| if( !single_tile_in_pic_flag ) { | |
| uniform_tile_spacing_flag | u(1) |
| if( uniform_tile_spacing_flag ) { | |
| tile_cols_width_minus1 | ue(v) |
| tile_rows_height_minus1 | ue(v) |
| } else { | |
| num_tile_columns_minus1 | ue(v) |
| num_tile_rows_minus1 | ue(v) |
| for( i = 0; i < num_tile_columns_minus1; i++ ) | |
| tile_column_width_minus1[ i ] | ue(v) |
| for( i = 0; i < num_tile_rows_minus1; i++ ) | |
| tile_row_height_minus1[ i ] | ue(v) |
| } | |
| brick_splitting_present_flag | u(1) |
| for( i = 0; brick_present_flag && i < NumTilesInPic; | |
| i++ ) { | |
| brick_split_flag[ i ] | u(1) |
| if( brick_split_flag[ i ] ) { | |
| uniform_brick_spacing_flag[ i ] | u(1) |
| if( uniform_brick_spacing_flag[ i ] ) | |
| brick_height_minus1[ i ] | ue(v) |
| else { | |
| num_brick_rows_minus1[ i ] | ue(v) |
| for(j = 0; j < num_brick_rows_minus1[ i ]; | |
| j++ ) | |
| brick_row_height_minus1[ i ][ j ] | ue(v) |
| } | |
| } | |
| } | |
| single_brick_per_slice_flag | u(1) |
| if( !single_brick_per_slice_flag ) | |
| rect_slice_flag | u(1) |
| if( rect_slice_flag && !single_brick_per_slice_flag ) { | |
| num_slices_in_pic_minus1 | ue(v) |
| for( i = 0; i <= num_slices_in_pic_minus1; i++ ) { | |
| if( i > 0 ) | |
| top_left_brick_idx[ i ] | u(v) |
| bottom_right_brick_idx_delta[ i ] | u(v) |
| } | |
| } | |
| loop_filter_across_bricks_enabled_flag | u(1) |
| if( loop_filter_across_bricks_enabled_flag ) | |
| loop_filter_across_slices_enabled_flag | u(1) |
| } | |
| if( rect_slice_flag ) { | |
| signalled_slice_id_flag | u(1) |
| if( signalled_slice_id_flag ) { | |
| signalled_slice_id_length_minus1 | ue(v) |
| for( i = 0; i <= num_slices_in_pic_minus1; i++ ) | |
| slice_id[ i ] | u(v) |
| } | |
| } | |
| entropy_coding_sync_enabled_flag | u(1) |
| ... | |

An example of general slice header syntax is as follows.

| | Descriptor |
|---|---|
| slice_header( ) { | |
| ... | ue(v) |
| if( rect_slice_flag \| \| NumBricksInPic > 1 ) | |
| slice_address | u(v) |
| if( !rect_slice_flag && !single_brick_per_slice_flag ) | |
| num_bricks_in_slice_minus1 | |
| ... | |
| if ( entropy_coding_sync_enabled_flag ) | |
| num_entry_point_offsets | ue(v) |
| if( NumEntryPoints > 0 ) { | |
| offset_len_minus1 | ue(v) |
| for( i = 0; i < NumEntryPoints; i++ ) | |
| entry_point_offset_minus1[ i ] | u(v) |
| } | |
| ... | |
| } | |

An example picture parameter set RBSP semantics is as follows. A single_tile_in_pic_flag may be set equal to one to specify that there is only one tile in each picture referring to the PPS. The single_tile_in_pic_flag may be set equal to zero to specify that there is more than one tile in each picture referring to the PPS. In absence of further brick splitting within a tile, the whole tile may be referred to as a brick. When a picture contains only a single tile without further brick splitting, the picture may be referred to as a single brick. For bitstream conformance, a value of single_tile_in_pic_flag should be the same for all PPSs that are activated within a CVS.

A uniform_tile_spacing_flag may be set equal to one to specify that tile column boundaries and likewise tile row boundaries are distributed uniformly across the picture and signaled using the syntax elements tile_cols_width_minus1 and tile_rows_height_minus1. The uniform_tile_spacing_flag may be set equal to zero to specify that tile column boundaries and likewise tile row boundaries may or may not be distributed uniformly across the picture and signaled using the syntax elements num_tile_columns_minus1 and num_tile_rows_minus1 and a list of syntax element pairs tile_column_width_minus1[i] and tile_row_height_minus1[i]. When not present, the value of uniform_tile_spacing_flag may be inferred to be equal to zero. The tile_cols_width_minus1 plus 1 specifies the width of the tile columns excluding the right-most tile column of the picture in units of CTBs when uniform_tile_spacing_flag is equal to one. The value of tile_cols_width_minus1 may be in the range of zero to PicWidthInCtbsY−1, inclusive. When not present, the value of tile_cols_width_minus1 is inferred to be equal to PicWidthInCtbsY−1.

The tile_rows_height_minus1 plus 1 specifies the height of the tile rows excluding the bottom tile row of the picture in units of CTBs when uniform_tile_spacing_flag is equal to one. The value of tile_rows_height_minus1 shall be in the range of zero to PicHeightInCtbsY−1, inclusive. When not present, the value of tile_rows_width_minus1 is inferred to be equal to PicHeightInCtbsY−1. The num_tile_columns_minus1 plus 1 specifies the number of tile columns partitioning the picture when uniform_tile_spacing_flag is equal to zero. The value of num_tile_columns_minus1 shall be in the range of zero to PicWidthInCtbsY−1, inclusive. If single_tile_in_pic_flag is equal to one, the value of num_tile_columns_minus1 is inferred to be equal to zero. Otherwise, when uniform_tile_spacing_flag is equal to one, the value of num_tile_columns_minus1 is inferred. The num_tile_rows_minus1 plus 1 specifies the number of tile rows partitioning the picture when uniform_tile_spacing_flag is equal to zero. The value of num_tile_rows_minus1 shall be in the range of zero to PicHeightInCtbsY−1, inclusive. If single_tile_in_pic_flag is equal to one, the value of num_tile_rows_minus1 is inferred to be equal to zero. Otherwise, when uniform_tile_spacing_flag is equal to one, the value of num_tile_rows_minus1 is inferred. The variable NumTilesInPic may be set equal to (num_tile_columns_minus1+1)*(num_tile_rows_minus1+1).

When single_tile_in_pic_flag is equal to zero, NumTilesInPic should be greater than one. The tile_column_width_minus1[i] plus 1 specifies the width of the i-th tile column in units of CTBs. The tile_row_height_minus1[i] plus 1 specifies the height of the i-th tile row in units of CTBs. The brick_splitting_present_flag may be set equal to one to specify that one or more tiles of pictures referring to the PPS may be divided into two or more bricks. The brick_splitting_present_flag may be set equal to zero to specify that no tiles of pictures referring to the PPS are divided into two or more bricks. The brick_split_flag[i] may be set equal to one to specify that the i-th tile is divided into two or more bricks. The brick_split_flag[i] may be set equal to zero to specify that the i-th tile is not divided into two or more bricks. When not present, the value of brick_split_flag[i] is inferred to be equal to zero.

The uniform_brick_spacing_flag[i] may be set equal to one to specify that brick boundaries are distributed uniformly across the i-th tile and signaled using the syntax element brick_height_minus1[i ]. The uniform_brick_spacing_flag[i] may be set equal to zero to specify that brick boundaries may or may not be distributed uniformly across i-th tile and signaled using the syntax element num_brick_rows_minus1[i] and a list of syntax elements brick_row_height_minus1[i][j]. When not present, the value of uniform_brick_spacing_flag[i] is inferred to be equal to one. The brick_height_minus1[i] plus 1 specifies the height of the brick rows excluding the bottom brick in the i-th tile in units of CTBs when uniform_brick_spacing_flag[i] is equal to one. When present, the value of brick_height_minus1 shall be in the range of zero to RowHeight[i]−2, inclusive. When not present, the value of brick_height_minus1[i] is inferred to be equal to RowHeight[i]−1. The num_brick_rows_minus1[i] plus 1 specifies the number of bricks partitioning the i-th tile when uniform_brick_spacing_flag[i] is equal to zero. When present, the value of num_brick_rows_minus1[i] may be in the range of one to RowHeight[i]−1, inclusive. If brick_split_flag[i] is equal to zero, the value of num_brick_rows_minus1[i] is inferred to be equal to zero. Otherwise, when uniform_brick_spacing_flag[i] is equal to one, the value of num_brick_rows_minus1[i] is inferred. The brick_row_height_minus1[i][j] plus 1 specifies the height of the j-th brick in the i-th tile in units of CTBs when uniform_tile_spacing_flag is equal to zero.

The following variables can derived, and, when uniform_tile_spacing_flag is equal to one, the values of num_tile_columns_minus1 and num_tile_rows_minus1 are inferred, and, for each i ranging from zero to NumTilesInPic−1, inclusive, when uniform_brick_spacing_flag[i] is equal to one, the value of num_brick_rows_minus1[i] is inferred, by invoking the CTB raster and brick scanning conversion process. The variables that can be derived include the list RowHeight[j] for j ranging from zero to num_tile_rows_minus1, inclusive, specifying the height of the j-th tile row in units of CTBs; the list CtbAddrRsToBs[ctbAddrRs] for ctbAddrRs ranging from 0 to PicSizeInCtbsY−1, inclusive, specifying the conversion from a CTB address in the CTB raster scan of a picture to a CTB address in the brick scan; the list CtbAddrBsToRs[ctbAddrBs] for ctbAddrBs ranging from 0 to PicSizeInCtbsY−1, inclusive, specifying the conversion from a CTB address in the brick scan to a CTB address in the CTB raster scan of a picture; the list BrickId[ctbAddrBs] for ctbAddrBs ranging from 0 to PicSizeInCtbsY−1, inclusive, specifying the conversion from a CTB address in brick scan to a brick ID; the list NumCtusInBrick[brickIdx] for brickIdx ranging from 0 to NumBricksInPic−1, inclusive, specifying the conversion from a brick index to the number of CTUs in the brick; and the list FirstCtbAddrBs[brickIdx] for brickIdx ranging from 0 to NumBricksInPic−1, inclusive, specifying the conversion from a brick ID to the CTB address in brick scan of the first CTB in the brick.

The single_brick_per_slice_flag may be set equal to one to specify that each slice that refers to this PPS includes one brick. The single_brick_per_slice_flag may be set equal to zero to specify that a slice that refers to this PPS may include more than one brick. When not present, the value of single_brick_per_slice_flag is inferred to be equal to one. The rect_slice_flag may be set equal to zero to specify that bricks within each slice are in raster scan order and the slice information is not signaled in PPS. The rect_slice_flag may be set equal to one to specify that bricks within each slice cover a rectangular region of the picture and the slice information is signaled in the PPS. When single_brick_per_slice_flag is equal to one the rect_slice_flag is inferred to be equal to one. The num_slices_in_pic_minus1 plus 1 specifies the number of slices in each picture referring to the PPS. The value of num_slices_in_pic_minus1 may be in the range of zero to NumBricksInPic−1, inclusive. When not present and single_brick_per_slice_flag is equal to one, the value of num_slices_in_pic_minus1 is inferred to be equal to NumBricksInPic−1.

The top_left_brick_idx[i] specifies the brick index of the brick located at the top-left corner of the i-th slice. The value of top_left_brick_idx[i] should not be equal to the value of top_left_brick_idx[ j ] for any i not equal to j. When not present, the value of top_left_brick_idx[i] is inferred to be equal to i. The length of the top_left_brick_idx[i] syntax element is Ceil(Log2(NumBricksInPic) bits. The bottom_right_brick_idx_delta[i] specifies the difference between the brick index of the brick located at the bottom-right corner of the i-th slice and top_left_brick_idx[i]. When single_brick_per_slice_flag is equal to one, the value of bottom_right_brick_idx_delta[i] is inferred to be equal to zero. The length of the bottom_right_brick_idx_delta[i] syntax element is Ceil(Log2(NumBricksInPic−top_left_brick_idx[i])) bits.

Bitstream conformance may require that a slice include either a number of complete tiles or only a subset of one tile. The variable NumBricksInSlice[i] and BricksToSliceMap[j], which specify the number of bricks in the i-th slice and the mapping of bricks to slices, may be derived as follows.

```
NumBricksInSlice[ i ] = 0
botRightBkIdx = top_left_brick_idx[ i ] + bottom_right_brick_idx_delta[ i ]
for( j = 0; j < NumBricksInPic; j++) {
  if( BrickColBd[ j ] >= BrickColBd[ top_left_brick_idx[ i ] ] &&
        BrickColBd[ j ] <= BrickColBd[ botRightBkIdx ] &&
```

| | |
|---|---|
| BrickRowBd[ j ] >= BrickRowlBd[ top_left_brick_idx[ i ] ] && | (7-34) |

```
          BrickRowBd[ j ] <= BrickColBd[ botRightBkIdx ] ) {
    NumBricksInSlice[ i ]++
    BricksToSliceMap[ j ] = i
  }
}
```

The loop_filter_across_bricks_enabled_flag may be set equal to one to specify that in-loop filtering operations may be performed across brick boundaries in pictures referring to the PPS. The loop_filter_across_bricks_enabled_flag may be set equal to zero to specify that in-loop filtering operations are not performed across brick boundaries in pictures referring to the PPS. The in-loop filtering operations include the deblocking filter, sample adaptive offset filter, and adaptive loop filter operations. When not present, the value of loop_filter_across_bricks_enabled_flag is inferred to be equal to one. The loop_filter_across_slices_enabled_flag may be set equal to one to specify that in-loop filtering operations may be performed across slice boundaries in pictures referring to the PPS. The loop_filter_across_slice_enabled_flag may be set equal to zero to specify that in-loop filtering operations are not performed across slice boundaries in pictures referring to the PPS. The in-loop filtering operations include the deblocking filter, sample adaptive offset filter, and adaptive loop filter operations. When not present, the value of loop_filter_across_slices_enabled_flag is inferred to be equal to zero.

The signalled_slice_id_flag may be set equal to one to specify that the slice ID for each slice is signaled. The signalled_slice_id_flag may be set equal to zero to specify that slice IDs are not signaled. When rect_slice_flag is equal to zero, the value of signalled_slice_id_flag is inferred to be equal to zero. The signalled_slice_id_length_minusl plus one specifies the number of bits used to represent the syntax element slice_id[i] when present, and the syntax element slice_address in slice headers. The value of signalled_slice_id_length_minus1 may be in the range of zero to fifteen, inclusive. When not present, the value of signalled_slice_id_length_minus1 is inferred to be equal to Ceil(Log2(num_slices_in_pic_minus1+1))−1.

The slice_id[i] specifies the slice ID of the i-th slice. The length of the slice_id[i] syntax element is signalled_slice_id_length_minus1+1 bits. When not present, the value of slice_id[i] is inferred to be equal to i, for each i in the range of zero to num_slices_in_pic_minus1, inclusive. The entropy_coding_sync_enabled_flag may be set equal to one to specify that a specific synchronization process for context variables is invoked before decoding the CTU that includes the first CTB of a row of CTBs in each brick in each picture referring to the PPS, and a specific storage process for context variables is invoked after decoding the CTU that includes the first CTB of a row of CTBs in each brick in each picture referring to the PPS. The entropy_coding_sync_enabled_flag may be set equal to zero to specify that no specific synchronization process for context variables is required to be invoked before decoding the CTU that includes the first CTB of a row of CTBs in each brick in each picture referring to the PPS, and no specific storage process for context variables is required to be invoked after decoding the CTU that includes the first CTB of a row of CTBs in each brick in each picture referring to the PPS. Bitstream conformance may require that the value of entropy_coding_sync_enabled_flag shall be the same for all PPSs that are activated within a CVS.

An example of general slice header semantics is as follows. The slice_address specifies the slice address of the slice. When not present, the value of slice_address is inferred to be equal to zero. If rect_slice_flag is equal to zero, the following applies. The slice address is the brick ID. The length of slice_address is Ceil(Log2(NumBricksInPic)) bits. The value of slice_address may be in the range of zero to NumBricksInPic−1, inclusive. Otherwise (rectslice_flag is equal to 1), the following applies. The slice address is the slice ID of the slice. The length of slice_address is signalled_slice_id_length_minus1+1 bits. If signalled_slice_id_flag is equal to zero, the value of slice_address shall be in the range of zero to numslices_in_pic_minus1, inclusive. Otherwise, the value of slice_address shall be in the range of zero to 2^{(signalled_slice_id_length_minus1+1)}−1, inclusive.

Bitstream conformance may require that the following constraints apply. The value of slice_address may not be equal to the value of slice_address of any other coded slice NAL unit of the same coded picture. The slices of a picture may not be in increasing order of their slice_address values. The shapes of the slices of a picture may be such that each brick, when decoded, shall have its entire left boundary and entire top boundary including a picture boundary or including boundaries of previously decoded brick(s). The num_bricks_in_slice_minus1, when present, specifies the number of bricks in the slice minus one. The value of num_bricks_in_slice_minus1 may be in the range of zero to NumBricksInPic−1, inclusive. When rect_slice_flag is equal to zero and single_brick_per_slice_flag is equal to one, the value of num_bricks_in_slice_minus1 is inferred to be equal to zero.

The variable NumBricksInCurrSlice, which specifies the number of bricks in the current slice, and SliceBrickIdx[i], which specifies the brick index of the i-th brick in the current slice, may be derived as follows.

| if( rect_slice_flag ) { | |
|---|---|
| sliceIdx = 0 | |
| while( slice_address != rect_slice_id[ sliceIdx ] ) | |
| sliceIdx++ | |
| NumBricksInCurrSlice = NumBricksInSlice[ sliceIdx ] | |
| brickIdx = top_left_brick_idx[ sliceIdx ] | |
| botBrickIdx = brickIdx + bottom_right_brick_idx_delta[ brickIdx ] | |
| for( bIdx = 0; brickIdx <= botBrickIdx; brickIdx++ ) | (7-38) |

```
  if( BricksToSliceMap[ brickIdx ] == sliceIdx )
    SliceBrickIdx[ bIdx++ ] = brickIdx
} else {
NumBricksInCurrSlice = num_bricks_in_slice_minus1 + 1
SliceBrickIdx[ 0 ] = slice_address
for( i = 1; i < NumBricksInCurrSlice; i++ )
  SliceBrickIdx[ i ] = SliceBrickIdx[ i − 1 ] + 1
}
```

The num_entry_point_offsets is used to specify the variable NumEntryPoints, which specifies the number of entry points in the current slice as follows:

NumEntryPoints=entropy_coding_sync_enabled_flag?num_entry_point_offsets:NumBricksInCurrSlice−1 (7-60)

The offset_len_minus1 plus 1 specifies the length, in bits, of the entry_point_offset_minus1[i] syntax elements. The value of offset_len_minus1 may be in the range of zero to thirty one, inclusive. The entry_point_offset_minus1[i] plus 1 specifies the i-th entry point offset in bytes, and is represented by offset_len_minus1 plus 1 bits. The slice data that follows the slice header includes a NumEntryPoints+1 subsets, with subset index values ranging from zero to NumEntryPoints, inclusive. The first byte of the slice data is considered byte zero. When present, emulation prevention bytes that appear in the slice data portion of the coded slice NAL unit are counted as part of the slice data for purposes of subset identification. Subset zero includes bytes zero to entry_point_offset_minus1[0], inclusive, of the coded slice data, subset k, with k in the range of one to NumEntryPoints−1, inclusive, includes bytes firstByte[k] to lastByte[k], inclusive, of the coded slice data with firstByte[k] and lastByte[k] defined as:

firstByte[k]=Σₙ₌₁^{k}(entry_point_offset_minus1[n−1]+1) (7-61)

lastByte[k]=firstByte[k]+entry_point_offset_minus1[k] (7-61)

The last subset (with subset index equal to NumEntryPoints) includes the remaining bytes of the coded slice data.

When entropy_coding_sync_enabled_flag is equal to zero, each subset may include all coded bits of all CTUs in the slice that are within the same brick, and the number of subsets (e.g., the value of NumEntryPoints+1) should be equal to the number of bricks in the slice.

When entropy_coding_sync_enabled_flag is equal to one, each subset k with k in the range of zero to NumEntryPoints, inclusive, may include all coded bits of all CTUs in a CTU row within a brick, and the number of subsets (e.g., the value of NumEntryPoints+1) may be equal to the total number of brick-specific luma CTU rows in the slice.

The preceding examples may include one or more problems. For example, a syntax element ltrp_in_slice_header_flag in the ref_pic_list_struct( ) may be conditioned on long_term_ref_pics_flag being equal to one. Consequently, when long_term_ref_pics_flag is equal to one, this flag exists in each of the candidate reference picture list structures, which can be many. This may results in a large SPS when long_term_ref_pics_flag is equal to one. In another example, the combination of the condition for the syntax element num_ref_idx_active_override_flag and the corresponding inference may be problematic. For example, the value of num_ref_idx_active_override_flag may be equal to one for I slices, and consequently the syntax element num_ref_idx_active_minus1[0] may be signaled for I slices for which num_ref_entries[0][RplsIdx[0]] is greater than one, which is not needed. In another example, when WPP is in use (e.g., when entropy_coding_sync_enabled_flag is equal to one), the syntax element num_entry_point_offsets may be signaled for the derivation of the variable NumEntryPoints. However, NumEntryPoints can be derived without such signaling.

In general, this disclosure describes techniques for improvements in video coding, including improvements in signaling of reference picture lists and improvements for signaling of entry points when WPP is in use. The description of the techniques is based on the under-development VVC, but may also apply to other video/media codec specifications.

One or more of the abovementioned problems may be solved as follows. In an example aspect, a method for decoding a video bitstream is disclosed, wherein a flag is included in a SPS. The flag specifies whether the POC LSBs of the long term reference picture (LTRP) entries in a reference picture list structure are present in the slice headers or in the reference picture list structure. For example, the flag may be a ltrp_in_slice_header_flag. In another example aspect, a method for decoding a video bitstream is disclosed, wherein the bitstream includes a flag that specifies whether a number of active entries of a reference picture list is explicitly signaled, and when the flag is not present, the value of the flag is inferred to be equal to zero when the slice is an I slice and inferred to be equal to one when the slice is a B or P slice. For example, the flag may be a num_ref_idx_active_override_flag. In another example aspect, a method for decoding a video bitstream is disclosed, wherein the bitstream includes a plurality of tiles in a picture, a wavefront parallel processing functionality is applied, and a number of entry points in a slice is inferred instead of explicitly signaled. For example, the number of entry points may be inferred to be the sum of the number of CTU rows in all the bricks included in the slice. In yet another example, the number of entry points may be represented by the variable NumEntryPoints.

An example sequence parameter set RBSP syntax is as follows.

| | Descriptor |
|---|---|
| seq_parameter_set_rbsp( ) { | |
| ... | |
| log2_max_pic_order_cnt_lsb_minus4 | ue(v) |
| sps_max_dec_pic_buffering_minus1 | ue(v) |
| long_term_ref_pics_flag | u(1) |
| if( long_term_ref_pics_flag ) | |
| ltrp_in_slice_header_flag | u(1) |
| sps_idr_rpl_present_flag | u(1) |
| rpl1_same_as_rpl0_flag | u(1) |
| for( i = 0; i < !rpl1_same_as_rpl0_flag ? 2 : | |
| 1; i++ ) { | |
| num_ref_pic_lists_in_sps[ i ] | ue(v) |
| for( j = 0; j < num_ref_pic_lists_in_sps[ | |
| i ]; j++) | |
| ref_pic_list_struct( i, j ) | |
| } | |
| ... | |

An example of general slice header syntax is as follows.

| | Descriptor |
|---|---|
| slice_header( ) { | |
| ... | |
| slice_pic_order_cnt_lsb | u(v) |
| if( ( NalUnitType != IDR_W_RADL && | |
| NalUnitType != IDR_N_LP ) | |
| \| \| sps_idr_rpl_present_flag ) { | |
| for( i = 0; i < 2; i++ ) { | |
| if( num_ref_pic_lists_in_sps[ i ] > 0 && | |
| ( i == 0 \| \| ( i == 1 && | |
| rpl1_idx_present_flag ) ) ) | |
| ref_pic_list_sps_flag[ i ] | u(1) |
| if( ref_pic_list_sps_flag[ i ] ) { | |
| if( num_ref_pic_lists_in_sps[ i ] > 1 && | |
| ( i == 0 \| \| ( i == 1 && | |
| rpl1_idx_present_flag ) ) ) | |
| ref_pic_list_idx[ i ] | u(v) |
| } else | |
| ref_pic_list_struct( i, num_ref_pic_lists_in_sps[ i | |
| ] ) | |
| for( j = 0;j < NumLtrpEntries[ i ][ RplsIdx[ i ] ]; | |
| j++ ) { | |
| if( ltrp_in_slice_header_flag) | |
| slice_poc_lsb_lt[ i ][ j ] | u(v) |
| delta_poc_msb_present_flag[ i ][ j ] | u(1) |
| if( delta_poc_msb_present_flag[ i ][ j ] ) | |
| delta_poc_msb_cycle_lt[ i ][ j ] | ue(v) |
| } | |
| } | |
| if( ( slice_type != I && num_ref_entries[ 0 ][ | |
| RplsIdx[ 0 ][ > 1) \| \| | |
| ( slice_type == B && num_ref_entries[ 1 ][ | |
| RplsIdx[ 1 ] ] > 1 ) ) { | |
| num_ref_idx_active_override_flag | u(1) |
| if( num_ref_idx_active_override_flag ) | |
| for( i = 0; i < ( slice_type == B ? 2: 1 ); i++ ) | |
| if( num_ref_entries[ i ][ RplsIdx[ i ] ] > 1 ) | |
| num_ref_idx_active_minus1[ i ] | ue(v) |
| } | |
| } | |
| ... | |

Reference picture list structure syntax

| | Descriptor |
|---|---|
| ref_pic_list_struct( listIdx, rplsIdx ) { | |
| num_ref_entries[ listIdx ][ rplsIdx ] | ue(v) |
| for( i = 0, j = 0; i < num_ref_entries[ listIdx ][ rplsIdx ]; | |
| i++) { | |
| if( long_term_ref_pics_flag ) | |
| st_ref_pic_flag[ listIdx ][ rplsIdx ][ i ] | u(1) |
| if( st_ref_pic_flag[ listIdx ][ rplsIdx ][ i ] ) { | |
| abs_delta_poc_st[ listIdx ][ rplsIdx ][ i ] | ue(v) |
| if( abs_delta_poc_st[ listIdx ][ rplsIdx ][ i ] > 0 ) | |
| strp_entry_sign_flag[ listIdx ][ rplsIdx ][ i ] | u(1) |
| } else if( !ltrp_in_slice_header_flag) | |
| rpls_poc_lsb_lt[ listIdx ][ rplsIdx ][ j++ ] | u(v) |
| } | |
| } | |

An example sequence parameter set RBSP semantics is as follows. The long_term_ref_pics_flag may be set equal to zero to specify that no LTRP is used for inter-prediction of any coded picture in the CVS. The long_term_ref_pics_flag may be set equal to one to specify that LTRPs may be used for inter-prediction of one or more coded pictures in the CVS. The ltrp_in_slice_header_flag may be set equal to zero to specify that the POC LSBs of the LTRP entries in each ref_pic_list_struct(listIdx, rplsIdx) syntax structure are present in the ref_pic_list_struct(listIdx, rplsIdx) syntax structure. The ltrp_in_slice_header_flag may be set equal to one to specify that the POC LSBs of the LTRP entries in each ref_pic_list_struct(listIdx, rplsIdx) syntax structure are not present in the ref_pic_list_struct(listIdx, rplsIdx) syntax structure.

An example of general slice header semantics is as follows. The slice_poc_lsb_lt[i][j] specifies the value of the picture order count modulo MaxPicOrderCntLsb of the j-th LTRP entry in the i-th reference picture list. The length of the slice_poc_lsb_lt[i][j] syntax element may be log2_max_pic_order_cnt_lsb_minus4+4 bits. The variable PocLsbLt[i][j] may be derived as follows:

PocLsbLt[i][j]=ltp_in_slice_header_flag?slice_poc_lsb_lt[i][j]:rpls_poc_lsb_lt[listIdx][RplsIdx[i]][j] (7-41)

The num_ref_idx_active_override_flag may be equal to one to specify that the syntax element num_ref_idx_active_minus1[0] is present for P and B slices and that the syntax element num_ref_idx_active_minus1[1] is present for B slices. The num_ref_idx_active_override_flag may be set equal to zero to specify that the syntax elements num_ref_idx_active_minus1[0] and num_ref_idx_active_minus1[1] are not present. When not present, the value of num_ref_idx_active_override_flag may be inferred as follows. If slice_type is equal to B or P, the value of num_ref_idx_active_override_flag may be inferred to be equal to one. Otherwise (slice_type is equal to I), the value of num_ref_idx_active_override_flag may be inferred to be equal to zero.

An example reference picture list structure semantics is as follows. The num_ref_entries[listIdx][rplsIdx] may specify the number of entries in the ref_pic_list_struct(listIdx, rplsIdx) syntax structure. The value of num_ref_entries[listIdx][rplsIdx] may be in the range of zero to sps_max_dec_pic_buffering_minus1+14, inclusive.

An another example, a general slice header syntax is as follows.

| | Descriptor |
|---|---|
| slice_header( ) { | |
| ... | ue(v) |
| if( rect_slice_flag \| \| NumBricksInPic > 1 ) | |
| slice_address | u(v) |
| if( !rect_slice_flag && !single_brick_per_slice_flag ) | |
| num_bricks_in_slice_minus1 | |
| ... | |
| if( NumEntryPoints > 0 ) { | |
| offset_len_minus1 | ue(v) |
| for( i = 0; i < NumEntryPoints; i++ ) | |
| entry_point_offset_minus1[ i ] | u(v) |
| } | |
| ... | |
| } | |

An example of general slice header semantics is as follows. The variable NumEntryPoints, which specifies the number of entry points in the current slice, may be derived as follows:

```
if( !entropy_coding_sync_enabled_flag )
    NumEntryPoints = NumBricksInCurrSlice − 1
else {
  for( numBrickSpecificCtuRowsInSlice = 0, i =0; i < NumBricksInCurrSlice; i++ ) (7-60)
      numBrickSpecificCtuRowsInSlice += BrickHeight[ SliceBrickIdx[ i ] ]
    NumEntryPoints = numBrickSpecificCtuRowsInSlice − 1
}
```

The offset_len_minus1 plus 1 specifies the length, in bits, of the entry_point_offset_minus1[i] syntax elements. The value of offset_len_minus1 may be in the range of zero to thirty one, inclusive.

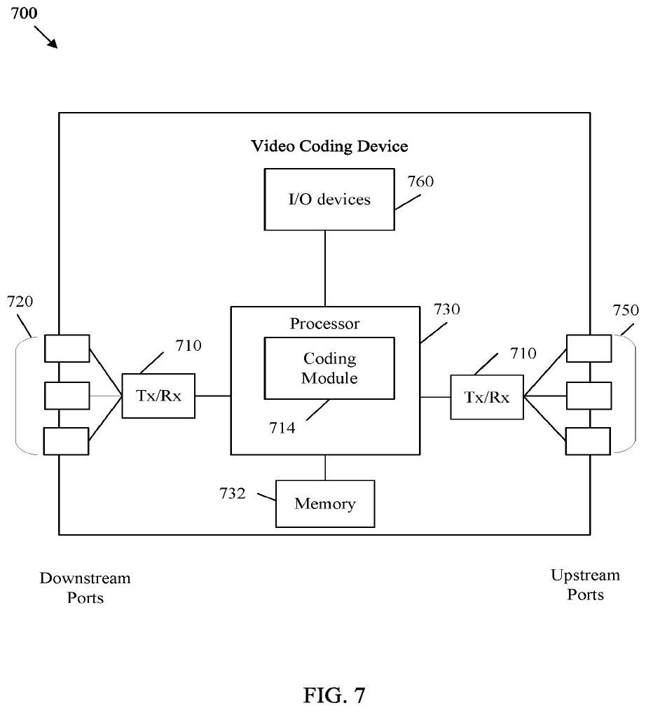

FIG. 7 is a schematic diagram of an example video coding device 700. The video coding device 700 is suitable for implementing the disclosed examples/embodiments as described herein. The video coding device 700 comprises downstream ports 720, upstream ports 750, and/or transceiver units (Tx/Rx) 710, including transmitters and/or receivers for communicating data upstream and/or downstream over a network. The video coding device 700 also includes a processor 730 including a logic unit and/or central processing unit (CPU) to process the data and a memory 732 for storing the data. The video coding device 700 may also comprise electrical, optical-to-electrical (OE) components, electrical-to-optical (EO) components, and/or wireless communication components coupled to the upstream ports 750 and/or downstream ports 720 for communication of data via electrical, optical, or wireless communication networks. The video coding device 700 may also include input and/or output (I/O) devices 760 for communicating data to and from a user. The I/O devices 760 may include output devices such as a display for displaying video data, speakers for outputting audio data, etc. The I/O devices 760 may also include input devices, such as a keyboard, mouse, trackball, etc., and/or corresponding interfaces for interacting with such output devices.

The processor 730 is implemented by hardware and software. The processor 730 may be implemented as one or more CPU chips, cores (e.g., as a multi-core processor), field-programmable gate arrays (FPGAs), application specific integrated circuits (ASICs), and digital signal processors (DSPs). The processor 730 is in communication with the downstream ports 720, Tx/Rx 710, upstream ports 750, and memory 732. The processor 730 comprises a coding module 714. The coding module 714 implements the disclosed embodiments described herein, such as methods 100, 800, and 900, which may include WPP 500 and/or a bitstream 600. The coding module 714 may also implement any other method/mechanism described herein. Further, the coding module 714 may implement a codec system 200, an encoder 300, and/or a decoder 400. For example, the coding module 714 can determine a value of NumEntryPoints 518 without receiving a num_entry_point_offsets parameter in a slice header of a bitstream. Hence, coding module 714 causes the video coding device 700 to provide additional functionality and/or coding efficiency when coding video data. As such, the coding module 714 improves the functionality of the video coding device 700 as well as addresses problems that are specific to the video coding arts. Further, the coding module 714 effects a transformation of the video coding device 700 to a different state. Alternatively, the coding module 714 can be implemented as instructions stored in the memory 732 and executed by the processor 730 (e.g., as a computer program product stored on a non-transitory medium).

The memory 732 comprises one or more memory types such as disks, tape drives, solid-state drives, read only memory (ROM), random access memory (RAM), flash memory, ternary content-addressable memory (TCAM), static random-access memory (SRAM), etc. The memory 732 may be used as an over-flow data storage device, to store programs when such programs are selected for execution, and to store instructions and data that are read during program execution.

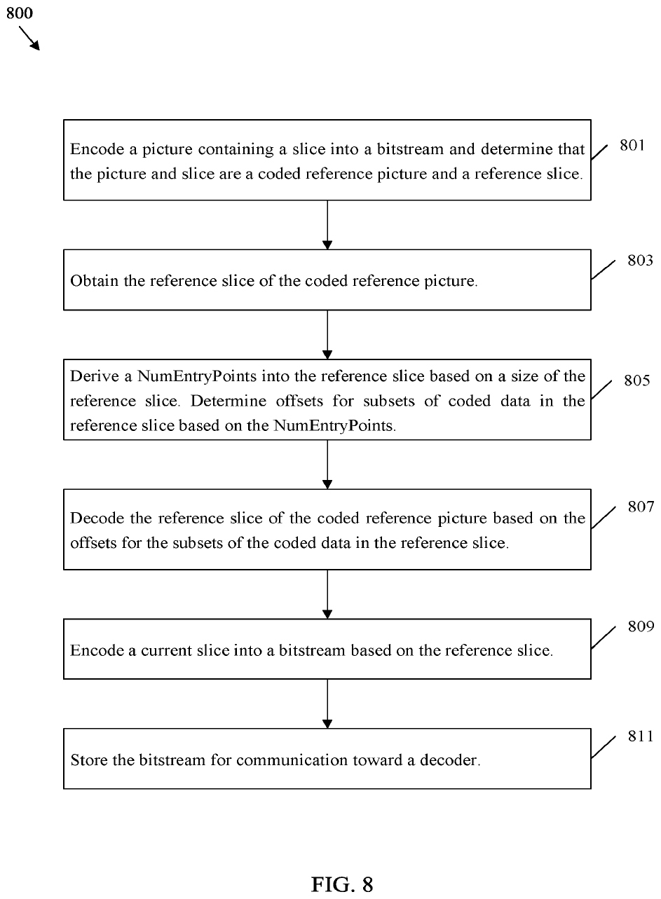

FIG. 8 is a flowchart of an example method 800 of encoding a video sequence into a bitstream, such as a bitstream 600 encoded with WPP 500, without signaling a NumEntryPoints for the slices in the video sequence. Method 800 may be employed by an encoder, such as a codec system 200, an encoder 300, and/or a video coding device 700 when performing method 100.

Method 800 may begin when an encoder receives a video sequence including a plurality of pictures and determines to encode that video sequence into a bitstream, for example based on user input. At step 801, the encoder may encode a picture containing a slice into a bitstream. The encoder can also determine that the picture and/or the slice should be used as a coded reference picture and/or a reference slice for another picture and/or slice, respectively. This picture/slice is referred to hereinafter as a current picture/current slice for purposes of clarity. Upon determining that the reference picture is to be used as a reference picture, the reference picture may be forwarded to a HRD for decoding. It should be noted that the encoder may encode a slice header into the bitstream. In an example, the slice header (e.g., for the reference slice and/or the current slice) does not include a value corresponding to the number of entry point offsets in the slice. For example, the slice header does not contain a num_entry_point_offsets parameter. At step 803, the HRD of the encoder obtains the reference slice of the coded reference picture either from the bitstream or from memory.

At step 805, the HRD of the encoder derives a NumEntryPoints into the reference slice based on a size of the reference slice. For example, the NumEntryPoints may be derived when the reference slice is coded according to WPP. In an example, the NumEntryPoints may further be derived based on a size of rows in the reference slice. In an example, the NumEntryPoints may further be derived based on a size of columns in the reference slice. In an example, the NumEntryPoints may further be derived based on a number of CTUs in the reference slice. In an example, the NumEntryPoints may further be derived based on addresses in the reference slice, such as CTU addresses. The HRD of the encoder can then determine offsets for subsets of coded data in the reference slice based on the NumEntryPoints. For example, the HRD can obtain an array of offsets. The HRD can then obtain a number of offsets from the array based on the NumEntryPoints. In an example, the subsets are CTU rows. Accordingly, the obtained offsets may indicate entry points for each CTU row in the slice.

For example, NumEntryPoints can be derived as follows:

```
if( !entropy_coding_sync_enabled_flag )
  NumEntryPoints = NumBricksInCurrSlice − 1
else {
  for( numBrickSpecificCtuRowsInSlice = 0, i =0; i < NumBricksInCurrSlice; i++ )
    numBrickSpecificCtuRowsInSlice += BrickHeight[ SliceBrickIdx[ i ] ]
  NumEntryPoints = numBrickSpecificCtuRowsInSlice − 1
}
```

where !entropy_coding_sync_enabled_flag indicates WPP 500 is not in use, NumBricksInCurrSlice is a number of tiles in a slice 501, numBrickSpecificCtuRowsInSlice is a number of CTU rows 521-525 in the slice 501, and BrickHeight[SliceBrickIdx[i]] is a height of the CTU rows 521-525 (and hence the height of a CTU column 516).

At step 807, the HRD at the encoder can decode the reference slice of the coded reference picture based on the offsets for the subsets of the coded data in the reference slice. For example, the HRD can obtain data for each CTU row starting at the bit in the memory or bitstream as indicated by the corresponding offset. The HRD can then decode each of the CTUs of the reference slice based on the obtained data.

At step 809, the encoder can encode a current slice into the bitstream based on the reference slice, for example by employing inter-prediction. The encoder can also store the bitstream for communication toward a decoder at step 811.

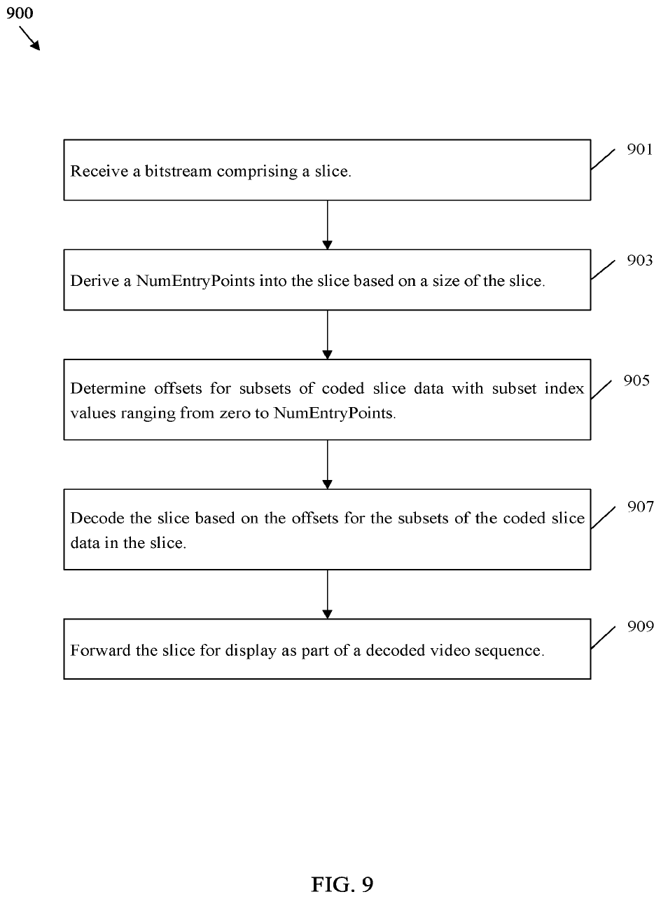

FIG. 9 is a flowchart of an example method 900 of deriving a NumEntryPoints to decode a video sequence when NumEntryPoints is not contained in a bitstream, such as a bitstream 600 encoded with WPP 500. Method 900 may be employed by a decoder, such as a codec system 200, a decoder 400, and/or a video coding device 700 when performing method 100.

Method 900 may begin when a decoder begins receiving a bitstream of coded data representing a video sequence, for example as a result of method 800. At step 901, the decoder receives a bitstream comprising a slice. For example, the slice may be a slice 501 coded according to WPP 500. The bitstream also comprises a slice header associated with the slice. In an example, the slice header does not include a value corresponding to the number of entry point offsets in the slice. For example, the slice header does not contain a num_entry_point_offsets parameter.

At step 903, the decoder derives a NumEntryPoints into the slice based on a size of the slice. For example, the NumEntryPoints may be derived when the slice is coded according to WPP. In an example, the NumEntryPoints may further be derived based on a size of rows in the slice. In an example, the NumEntryPoints may further be derived based on a size of columns in the slice. In an example, the NumEntryPoints may further be derived based on a number of CTUs in the slice. In an example, the NumEntryPoints may further be derived based on addresses in the slice, such as CTU addresses.

For example, NumEntryPoints can be derived as follows:

```
if( !entropy_coding_sync_enabled_flag )
  NumEntryPoints = NumBricksInCurrSlice − 1
else {
  for( numBrickSpecificCtuRowsInSlice = 0, i =0; i < NumBricksInCurrSlice; i++ )
    numBrickSpecificCtuRowsInSlice += BrickHeight[ SliceBrickIdx[ i ] ]
  NumEntryPoints = numBrickSpecificCtuRowsInSlice − 1
}
```

where !entropy_coding_sync_enabled_flag indicates WPP 500 is not in use, NumBricksInCurrSlice is a number of tiles in a slice 501, numBrickSpecificCtuRowsInSlice is a number of CTU rows 521-525 in the slice 501, and BrickHeight[SliceBrickIdx[i]] is a height of the CTU rows 521-525 (and hence the height of a CTU column 516).

At step 905, the decoder can determine offsets for subsets of coded slice data contained in the slice based on the NumEntryPoints as derived at step 903. For example, the decoder can obtain an array of offsets. The decoder can then obtain a number of offsets from the array based on the NumEntryPoints derived at step 903. For example, the offsets of the coded slice data may each be associated with a subset index value, and such values can range from zero to NumEntryPoints. The decoder can then iteratively obtain each offset at the corresponding subset index value until NumEntryPoints is reached. In an example, the subsets are CTU rows. Accordingly, the obtained offsets may indicate entry points for each CTU row in the slice.

At step 907, the decoder decodes the slice based on the offsets for the subsets of the coded slice data. For example, the decoder can obtain data for each CTU row starting at the bit in the bitstream as indicated by the corresponding offset. The decoder can then decode each of the CTUs of the slice based on the obtained data. The decoder can then forward the slice for display as part of a decoded video sequence at step 909.

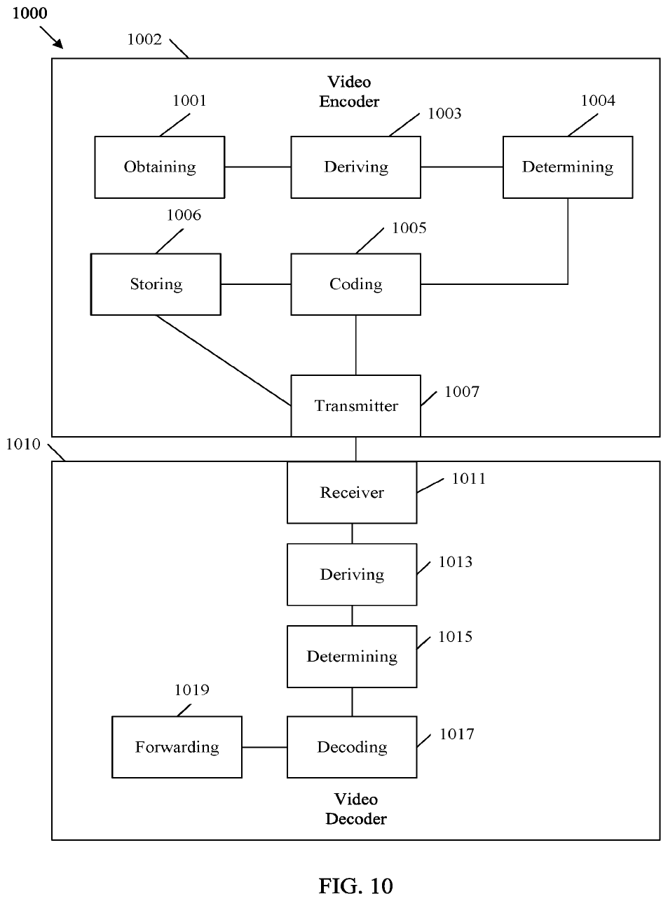

FIG. 10 is a schematic diagram of an example system 1000 for coding a video sequence into a bitstream, such as a bitstream 600 coded according to WPP 500, without signaling NumEntryPoints. System 1000 may be implemented by an encoder and a decoder such as a codec system 200, an encoder 300, a decoder 400, and/or a video coding device 700. Further, system 1000 may be employed when implementing method 100, 800, and/or 900.

The system 1000 includes a video encoder 1002. The video encoder 1002 comprises an obtaining module 1001 for obtaining a reference slice of a coded reference picture. The video encoder 1002 further comprises a deriving module 1003 for deriving a NumEntryPoints into the reference slice based on a size of the reference slice. The video encoder 1002 further comprises a determining module 1004 for determining offsets for subsets of coded data in the reference slice based on the NumEntryPoints. The video encoder 1002 further comprises a coding module 1005 for decoding the reference slice of the coded reference picture based on the offsets for the subsets of the coded data in the reference slice. The coding module 1005 is further for encoding a current slice into a bitstream based on the reference slice. The video encoder 1002 further comprises a storing module 1006 for storing the bitstream for communication toward a decoder. The video encoder 1002 further comprises a transmitting module 1007 for transmitting the bitstream toward a video decoder 1010. The video encoder 1002 may be further configured to perform any of the steps of method 800.

The system 1000 also includes a video decoder 1010. The video decoder 1010 comprises a receiving module 1011 for receiving a bitstream comprising a slice. The video decoder 1010 further comprises a determining module 1013 for deriving a NumEntryPoints into the slice based on a size of the slice. The video decoder 1010 further comprises a determining module 1015 for determining offsets for subsets of coded slice data with subset index values ranging from zero to the NumEntryPoints. The video decoder 1010 further comprises a decoding module 1017 for decoding the slice based on the offsets for the subsets of the coded data in the slice. The video decoder 1010 further comprises a forwarding module 1019 for forwarding the slice for display as part of a decoded video sequence. The video decoder 1010 may be further configured to perform any of the steps of method 900.

A first component is directly coupled to a second component when there are no intervening components, except for a line, a trace, or another medium between the first component and the second component. The first component is indirectly coupled to the second component when there are intervening components other than a line, a trace, or another medium between the first component and the second component. The term “coupled” and its variants include both directly coupled and indirectly coupled. The use of the term “about” means a range including ±10% of the subsequent number unless otherwise stated.

It should also be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present disclosure.

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, components, techniques, or methods without departing from the scope of the present disclosure. Other examples of changes, substitutions, and alterations are ascertainable by one skilled in the art and may be made without departing from the spirit and scope disclosed herein.

What is claimed is:

1. A method implemented by a decoder, the method comprising:
receiving, by a receiver of the decoder, a bitstream comprising a slice;
deriving, by a processor of the decoder, a number of entry points (NumEntryPoints) in the slice;
determining, by the processor, offsets for subsets of coded slice data with subset index values ranging from zero to the NumEntryPoints; and
decoding, by the processor, the slice based on the offsets for the subsets of the coded slice data.

2. The method of claim 1, wherein the NumEntryPoints is derived when the slice is coded according to wavefront parallel processing (WPP).

3. The method of claim 1, wherein the bitstream comprises a slice header, and wherein the slice header does not include a value corresponding to a number of entry point offsets in the slice.

4. The method of claim 1, wherein the NumEntryPoints is derived based on a size of rows in the slice.

5. The method of claim 1, wherein the NumEntryPoints is derived based on a size of columns in the slice.

6. The method of claim 1, wherein the NumEntryPoints is derived based on a number of coding tree units (CTUs) in the slice.

7. The method of claim 1, wherein the NumEntryPoints is derived based on addresses in the slice.

8. The method of claim 1, wherein the NumEntryPoints is derived based on a size of the slice.

9. A method implemented by an encoder, the method comprising:
obtaining, by a processor of the encoder, a reference slice of a coded reference picture;
deriving, by the processor, a number of entry points (NumEntryPoints) in the reference slice;
determining, by the processor, offsets for subsets of coded data in the reference slice based on the NumEntryPoints;
decoding, by the processor, the reference slice of the coded reference picture based on the offsets for the subsets of the coded data in the reference slice;
encoding, by the processor, a current slice into a bitstream based on the reference slice; and
storing, by a memory coupled to the processor, the bitstream for communication toward a decoder.

10. The method of claim 9, wherein the NumEntryPoints is derived when the reference slice is coded according to wavefront parallel processing (WPP).

11. The method of claim 9, wherein the bitstream comprises a slice header, and wherein the slice header does not include a value corresponding to a number of entry point offsets in the reference slice.

12. The method of claim 9, wherein the NumEntryPoints is derived based on a size of rows in the reference slice.

13. The method of claim 9, wherein the NumEntryPoints is derived based on a size of columns in the reference slice.

14. The method of claim 9, wherein the NumEntryPoints is derived based on a number of coding tree units (CTUs) in the reference slice.

15. The method of claim 9, wherein the NumEntryPoints is derived based on addresses in the reference slice.

16. The method of claim 9, wherein the NumEntryPoints is derived based on a size of the reference slice.

17. A video decoding device, comprising:
a memory storing instructions; and
one or more processors coupled to the memory, the one or more processors configured to execute the instructions to cause the video decoding device to:
receive a bitstream comprising a slice;
derive a number of entry points (NumEntryPoints) in the slice;
determine offsets for subsets of coded slice data with subset index values ranging from zero to the NumEntryPoints; and
decode the slice based on the offsets for the subsets of the coded slice data.

18. The video decoding device of claim 17, wherein the NumEntryPoints is derived when the slice is coded according to wavefront parallel processing (WPP).

19. The video decoding device of claim 17, wherein the bitstream comprises a slice header, and wherein the slice header does not include a value corresponding to a number of entry point offsets in the slice.

20. The video decoding device of claim 17, wherein the NumEntryPoints is derived based on one or more of a size of rows in the slice, a size of columns in the slice, a number of coding tree units (CTUs) in the slice, addresses in the slice, and a size of the slice.
